(19) United States
(12) Patent Application Publication
(10) Pub. No.: US 2026/0252887 A1
(43) Pub. Date: Aug. 27, 2026

(54) NEURAL NETWORK METHODS

(71) Applicant: UNIVERSITY OF SOUTHERN CALIFORNIA, Los Angeles, CA (US)

(72) Inventors: Syamil MOHD RAZAK, Los Angeles, CA (US); Jodel CORNELIO, Los Angeles, CA (US); Behnam JAFARPOUR, Los Angeles, CA (US); Young Hyun CHO, Los Angeles, CA (US)

(73) Assignee: UNIVERSITY OF SOUTHERN CALIFORNIA, Los Angeles, CA (US)

(21) Appl. No.: 18/861,546

(22) PCT Filed: May 1, 2023
(86) PCT No.: PCT/US2023/020522

§ 371 Date: Oct. 29, 2024

Related U.S. Application Data
(60) Provisional application No. 63/336,931, filed on Apr. 29, 2022.

(51) Int. Cl. G06N 3/084

(52) U.S. Cl. CPC G06N 3/084

(57) ABSTRACT

Computer implement methods that incorporated with statistical information from physical functions is provided. In particular, an artificial neural network with embedded physical functions is provided. Predictions from a physics-constrained neural network using residual learning are also described. Other aspects are directed to transfer learning.

### CROSS-REFERENCE TO RELATED APPLICATIONS

This application claims the benefit of U.S. provisional application Ser. No. 63/336,931 filed Apr. 29, 2022, the disclosure of which is hereby incorporated in its entirety by reference herein.

### TECHNICAL FIELD

In at least one aspect, the present invention relates to neural network methods, and in particular, statistical machine learning methods. In other aspects, the present invention relates to predictive modeling for subsurface flow systems using artificial neural networks.

### BACKGROUND

Many existing neural network predictive models do not offer a convenient way to incorporate known physical information. Training a large neural network predictive model with limited data can result in poor predictive performance (e.g., because of overfitting). The inclusion of information from a vast dataset generated from physical functions into a neural network can improve predictive performance.

Transfer Learning is a popular method to alleviate constraints in training a reliable model when limited data is available in a new field. Transfer learning focuses on storing knowledge gained while solving one problem (source data) and applying it to a different but related problem (target data). However, a methodology is required to incorporate knowledge from multiple relative datasets, if only the source models and not the data are available for training models for the target dataset. Moreover, the transfer of incorrect knowledge will lead to negative transfer and impede the performance of the training in the new field.

Physics-constrained neural networks contain embedded physical functions that can constrain the prediction thus resulting in poor performance, especially when the embedded physical functions do not fully represent the relationship between the input and output dataset. The difference between the ground truth and the prediction from a physics-constrained neural network for any given input is termed residual.

Accordingly, there is a need for improved neural network methods for statistical machine learning and for predictive modeling.

### SUMMARY

In at least one aspect, an artificial neural network that is incorporated with statistical information from physical functions is provided. The physical functions are incorporated into the neural network by first training parts of the neural network with data generated from the physical functions. In the subsequent training process, another set of data is used that may come from the field or other physical functions. Characteristically, the parts that have been initially trained using data from the physical functions are not allowed to change. The parts of the neural network that were not included in the initial training process are allowed to be trained in the subsequent training process. Following the two steps of training, the artificial neural network represents the statistical information from the initial physical functions and other sets of field data or physical functions.

In another aspect, an artificial neural network with embedded physical functions is provided. A physical function is incorporated into the neural network by allowing the output of the preceding neural network to serve as an input into the physical function. Any physical function can be embedded within a neural network given that the size of output from the immediately preceding part of the neural network agrees with the size of the input into the physical function. As such, multiple physical functions can be embedded within a neural network. The neural network is trained with a training dataset where the size of the output agrees with the size of the output from the last embedded physical function. During training, only the weights within the neural network are trained and there are no weights that need to be trained within the physical functions. Using a backpropagation algorithm, the gradient information flows from the objective function through the physical functions by invoking the chain rule. The gradient can be calculated using a closed-form solution when available or approximated through finite-difference methods. Once trained to convergence, the physical functions are embedded in the artificial neural network.

In another aspect, a method to improve the predictions from a physics-constrained neural network using residual learning is provided. Physics-constrained neural networks contain embedded physical functions that can constrain the prediction thus resulting in poor performance, especially when the embedded physical functions do not fully represent the relationship between the input and output dataset. In physics-constrained neural networks, the physical functions can be embedded as parts of the neural network that statistically represent the physical functions or embedded as it is. When a dataset cannot be fully represented by a physics-constrained neural network due to the lack of relevance of the embedded physical functions, the physics-constrained neural network can give a prediction with a large error when compared to the ground-truth, for any given input. The difference between the ground truth and the prediction from a physics-constrained neural network for any given input is termed the residual and is calculated through subtraction. This invention improves the prediction from a physics-constrained neural network by introducing an additional neural network component to learn the residual for any given input. Specifically, the additional neural network component is trained with a training dataset where the input dataset is the same input for the physics-constrained neural network and the output dataset is the calculated residuals. The present invention results in a final prediction that combines through addition, the prediction from the physics-constrained neural network with the predicted residual from the additional neural network component.

In another aspect, a method to identify and rank source models to facilitate transfer learning is provided. Production data from multiple different fields have different factors that affect them. These effects are difficult to discern by simply looking at production profiles from different fields and comparing it to a target field. A data-driven method is required to identify and isolate the fields that have similar characteristics and then rank them in terms of suitability for transfer to a target field. Once the appropriate ranking is obtained with a suitable metric, the models can be transferred to retrain for a target dataset. First, a physical function is used to isolate the differing factors, this is done by subtracting the physical function from the production data and obtaining the respective residuals. The residuals are then sent through 1-D convolution layers to extract the temporal features and reduce them to low dimensional space. The lower-dimensional representation of these residuals allows us to easily distinguish them from each other in the latent space as similar features tend to form their own clusters. The residuals of the target field can then be projected into the same space and an appropriate metric is selected to compare it to the existing clusters. Depending on the metric selected, the dataset of the cluster with the closest proximity to the projected target dataset is the highest-ranked source model that can be picked. The metric can also be used to rank the remaining source models with respect to the target dataset. Once the ranking is done and the right source models are picked, they can be transferred to train a model for the target dataset that is limited in number to avoid overfitting and negative transfer.

In another aspect, a methodology that allows the aggregation of multiple artificial neural networks in order to facilitate transfer learning from multiple source models is provided. A certain target dataset that is limited in number may have relevant features that are present in multiple data sets. A framework is required such that all relevant source models can be combined in a single network when being transferred to the target dataset. The invention allows for combining the outputs of the different source models that are fixed when retraining for the target dataset. The outputs from the different source models are used as input to another neural network, whose function is to incorporate the right features from the different outputs such that it matches the output of the target dataset. Once this entire aggregated network is retrained on the target dataset, it can be used to make predictions.

In another aspect, a data-driven method to identify which source models are accurate and are contributing to a target dataset to facilitate transfer learning is provided. A certain target dataset that is limited in number may be similar to just one source dataset or may have relevant features that are present in multiple datasets. Production data from multiple different fields have different factors that affect them. These effects are difficult to discern by simply looking at production profiles from different fields and comparing them to a target field. A framework is required such that when different source models are combined in a single network to be transferred to the target dataset, it can be discerned which source model is the best representative of the target dataset or if multiple source models are contributing features to the target dataset. The invention allows for combining the outputs of the different source models that are fixed when retraining for the target dataset and determining which models best represents the target dataset. The outputs from the different source models are used as input to another neural network with a SoftMax activation function, whose function is to convert the vector of numbers into a vector of probabilities, where the probabilities of each value are proportional to the relative scale of each value in the vector and the probabilities sum up to 1. Once this entire aggregated network is retrained on the target dataset, its activations can be seen to determine the right source model or if multiple source models contribute to the output.

In another aspect, a computer-implemented method for incorporating statistical information from physical functions into a neural network is provided. The neural network includes a first neural network component representing a first function and a second neural network component representing a physical function such that the second neural network component receives input from the first neural network component. Each of the first neural network components and the second neural network component independently includes one or more fully-connected artificial neural network layers. The method includes a step of training by backpropagation of the second neural network component with a first training dataset generated from at least one initial physical function in a first training phase to form a trained second neural network component where the first training dataset including pairs of input to and an output from the second neural network component. The method also includes a step of training by backpropagation a combination of the first neural network component and the second neural network component with a second training dataset in a second training phase to form a trained neural network such that weight in the second neural network component are not allowed to change. The second training dataset is generated from field data or other physical functions. The first training dataset includes pairs of an input to the first neural network component and an output from the second neural network component. Characteristically, the trained neural network represents the statistical information from at least one initial physical function and other sets of field data or physical functions.

In another aspect, a computer-implemented method for to combine physical functions into a neural network is provided. The neural network includes a first neural network component and a second neural network component such that the second neural network component receives input from the first neural network component where the second neural network component is a physical function. The method includes a step of training the neural network with a first training dataset such that only weights in the first neural network component are trained by backpropagation. Characteristically, the first training dataset includes pairs of inputs to the first neural network component and outputs from the second neural network component.

In another aspect, a computer-implemented method for improving improved prediction of a neural network. The method improves prediction for any given input by augmenting a prediction from a first neural network component which is a physics-constrained neural network with a predicted residual output from a second neural network component that is a trained neural network is provided. The method includes a training phase that has a step of obtaining a training dataset that includes dataset pairs of a training input to the first neural network component and a training output from the first neural network component. The training phase also includes steps of calculating a calculated output from the first neural network component for each training input, calculating the predicted residual output as the difference between the calculated output and the training output, and training the second neural network component with a second training dataset that includes pairs of the training input and the predicted residual output.

In another aspect, the computer-implemented method for improving prediction of a neural network includes a prediction phase. The prediction phase includes steps of providing a set of input data; calculating the calculated output from the first neural network component for each input in the set of input data; calculating a residual output from the second neural network component for each input in the set of input data, and calculating a final output as the sum of the residual output and the calculated output.

In another aspect, a computer-implemented method to identify and rank source models for transfer learning with a neural network is provided. The computer-implemented method includes steps of providing a plurality of input datasets and isolating unique characteristics of each dataset in the plurality of input datasets by subtracting a predetermined function from each input dataset to obtain a residual dataset for each input dataset. The computer-implemented method also includes a step of generating a low-dimensional representation with an encoder by the neural network receiving as input each residual dataset, the neural network passing the residual dataset through a series of successive layers thereby generating a low-dimensional representation as a set of latent variables for each residual dataset.

In another aspect, a computer-implemented method for aggregating source models predictions for transfer learning with a neural network is provided. The neural network includes multiple neural network components that provide input to a final neural network component. Characteristically, each of the multiple neural network components corresponds to a source model. The computer-implemented method includes a step of training, by backpropagation, each of the multiple neural network components corresponding to a source model with different datasets. The method also includes a step of training the final neural network component with a first training dataset including pairs of inputs to the multiple neural network components and an output from the final neural network component. The training of the final neural network component is performed without varying weight in the multiple neural network components. Advantageously, the final neural network component incorporates features from the different outputs of the multiple neural network components such that the final neural network component's output matches output of the first training dataset thereby allowing the neural network to make predictions.

In another aspect, a computer-implemented method for identifying which source models are accurate and are contributing to a target dataset to facilitate transfer learning with a neural network is provided. The neural network includes multiple neural network components that provide input to a final neural network component. The computer-implemented method includes a step of training, by backpropagation, each of the multiple neural network components corresponding to a source model with different datasets. The method also includes training the final neural network component with a first training dataset including pairs of inputs to the multiple neural network components and an output from the final neural network component. Characteristically, the training of the final neural network component is performed without varying weight in the multiple neural network components. Advantageously, the final neural network component includes a first layer that applies a SoftMax activation function before being mapped to a final output vector, the first layer is designed such that the number of hidden nodes is the same as the number of source models used during training of the final neural network component such that activations can be extracted to determine the probabilities of the different source models relative to a target dataset.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1-1 is a schematic representation of the present invention showing workflow with known constraining physics;

FIG. 1-2 shows a workflow to generate training data for the embodiment depicted in FIG. 1A-1;

FIG. 1-3 shows the performance of the present invention on the test dataset;

FIG. 1-4 shows examples of prediction from the present invention on the test dataset;

FIG. 2-1 is a schematic representation of the present invention;

FIG. 2-2 shows a workflow to generate training data for the present invention;

FIG. 2-3 shows the performance of the present invention on the test dataset;

FIG. 2-4 shows examples of prediction from the present invention on the test dataset;

FIG. 3-1 is a schematic representation of the present invention;

FIG. 3-2 shows a workflow to generate the final prediction of the present invention;

FIG. 3-3 shows a workflow to generate training data for demonstration of the present invention;

FIG. 3-4 shows performance of the present invention on the test dataset;

FIG. 3-5 shows examples of prediction from the present invention on the test dataset;

FIG. 4-1 shows a sample of the different datasets used;

FIG. 4-2 shows a sample of the residuals which is the input for the motivating example;

FIG. 4-3 is a schematic representation of the present invention;

FIG. 4-4 shows latent space representations of the source datasets;

FIG. 4-5 shows latent space representations of the source datasets with the target dataset;

FIG. 4-6 shows distance metric used to rank the different source datasets relative to the target dataset;

FIG. 4-7 shows the performance metric of the different source models.

FIG. 5-1 is a schematic representation of the present invention;

FIG. 5-2 shows a sample of the source and target datasets for the motivating example;

FIG. 5-3 shows performance of the present invention on the test dataset;

FIG. 5-4 shows summary of prediction from the present invention on the test dataset;

FIG. 6-1 is a schematic representation of the present invention;

FIG. 6-2 shows a sample of the different datasets used;

FIG. 6-3 shows the performance of the present invention on the test dataset; and

FIG. 6-4 shows average activation for the predictions of the test dataset, and shows the probabilities of each source model relative to the target dataset.

FIG. 7A is a schematic representation of the present invention showing workflow with unknown constraining physics and known residual.

FIG. 7B is a schematic representation of the present invention showing workflow with unknown constraining physics and unknown residual.

FIG. 8A provides a schematic of the Physics-Guided Deep Learning (PGDL) model.

FIG. 8B provides an example of a diagram of the statistical PGDL model architecture.

FIG. 8C provides workflow of the Physics-Guided Deep Learning (PGDL) model.

FIG. 9. Schematic of a computer system implementing the methods set forth herein.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

When a computing device is described as performing an action or method step, it is understood that the computing device is operable to perform the action or method step typically by executing one or more lines of source code. The actions or method steps can be encoded onto non-transitory memory (e.g., hard drives, optical drives, flash drives, and the like).

The term “computing device” generally refers to any device that can perform at least one function, including communicating with another computing device. In a refinement, a computing device includes a central processing unit that can execute program steps and memory for storing data and a program code. Computing devices can be laptop computers, desktop computers, servers, smart devices such as cell phones and tablets, and the like.

The term “neural network” refers to a machine learning model that can be trained with training input to approximate unknown functions. In a refinement, neural networks include a model of interconnected digital neurons that communicate and learn to approximate complex functions and generate outputs based on a plurality of inputs provided to the model. It should be appreciated that neural networks capture statistical relationships by learning from large amounts of data through a process called training. During training, the neural network adjusts its weights to minimize the difference between its output and the expected output. This process is done using optimization algorithms, such as gradient descent, that update the weights in a way that reduces the difference between the predicted and expected output. As the neural network learns from the data, it captures statistical relationships by identifying patterns and correlations in the input data and output data.

As used herein, a “physical function” can be any function with and input and output. In a refinement, a physical function is a relation between inputs and outputs that are related by physics base principles and/or equations. A physical function can refer to a mathematical function that describes a physical quantity or phenomenon, such as force, velocity, acceleration, energy, or temperature, in terms of one or more independent variables, such as time, distance, or position. Physical functions can take a variety of mathematical forms, such as linear, quadratic, exponential, or trigonometric functions, depending on the specific physical phenomenon being described. These functions can be used to model, simulate, or predict the behavior of physical systems.

Throughout this application, where publications are referenced, the disclosures of these publications in their entireties are hereby incorporated by reference into this application to more fully describe the state of the art to which this invention pertains.

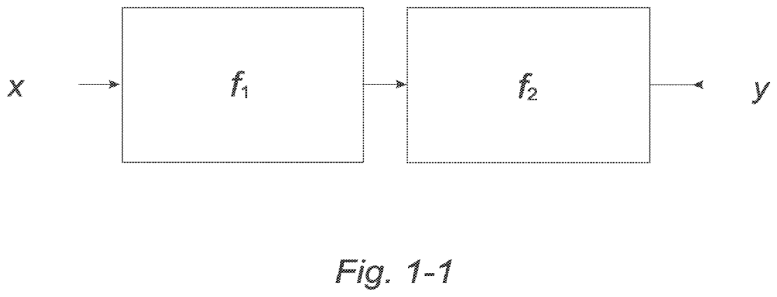

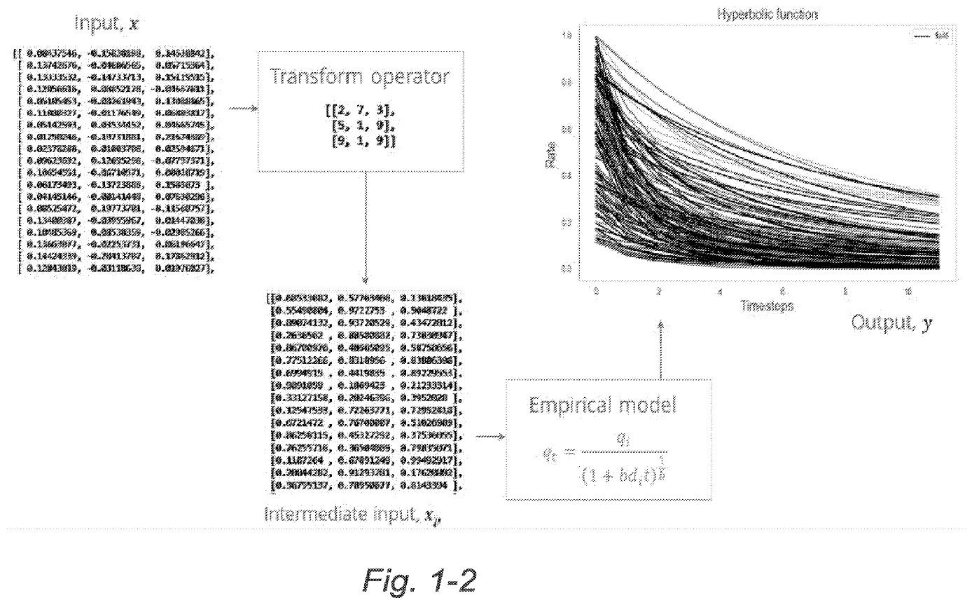

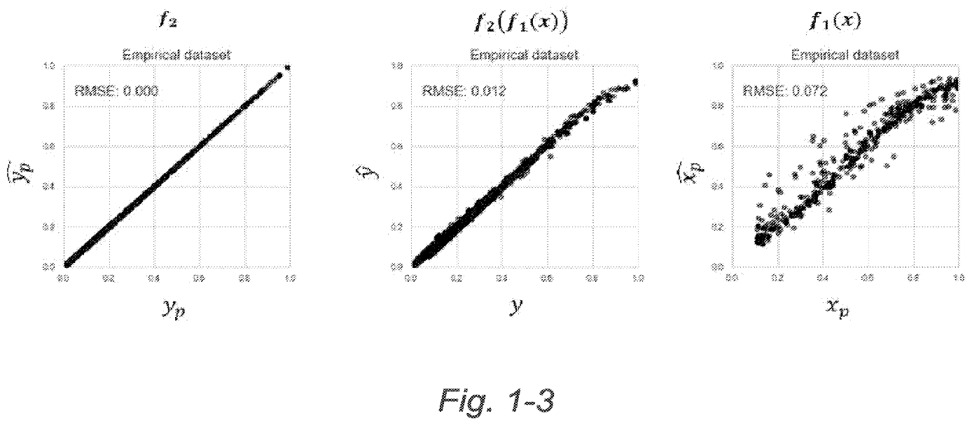

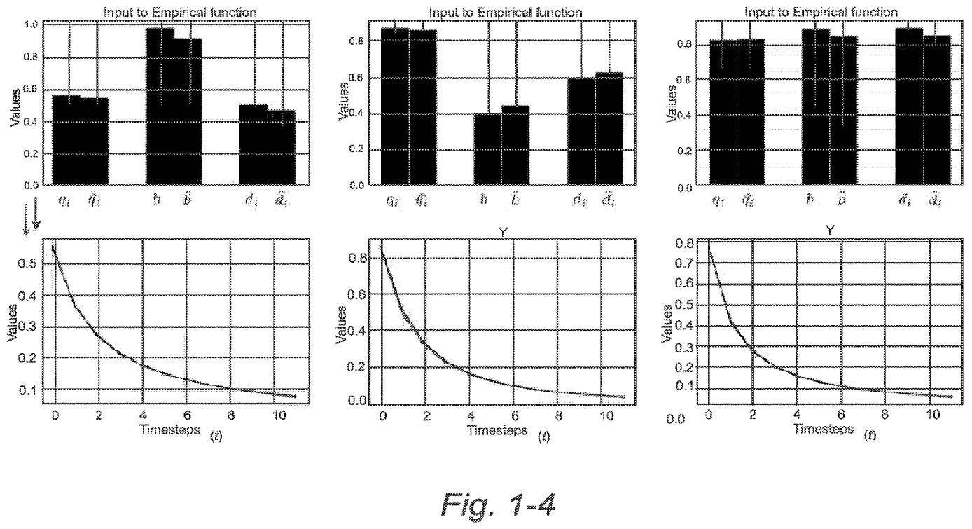

In a first embodiment, a computer-implemented method to incorporate physical functions into a neural network by selective training is provided. The computer-implemented method uses several fully-connected artificial neural network layers that form both ƒ₁ (i.e., a first neural network component) and ƒ₂ (i.e., a second neural network component) shown in FIG. 1-1. A fully-connected layer with a nonlinear activation function ƒ(⋅) is defined as Z=ƒ(W_{d}A+b_{d}) where A∈R^{N}^{_{b}}^{×N}^{ᵢ} denotes the input into the layer, N_{b} is the batch size of the input, Nᵢ is the size of the input, W_{d}∈R^{N}^{_{b}}^{×N}^{ᵢ} represents the weights to be trained, N_{d} is the number of hidden nodes of the fully-connected layer, and b_{d}∈R^{N}^{_{d}}^{×1} represents the bias term. The output of each fully-connected layer is denoted as Z. Several fully-connected layers are stacked to form both ƒ₁ and ƒ₂ where the training data input and output pairs arc respectively denoted as x and y. Referring now to the present invention shown in FIG. 1-1 in more detail, ƒ₂ represent parts of the neural network that are to represent the physical functions. Given an arbitrary physical function ƒₚ, the input xₚ is sampled from a range of values relevant to the physical function and the corresponding output yₚ is calculated as yₚ=ƒₚ (xₚ). The pairs of xₚ and yₚ are used as the training data to train the weights within ƒ₂ using a backpropagation algorithm. Specifically, in the initial training step, the forward computation is yₚ=ƒ₂(xₚ) where once convergence is reached, the parts of the neural network denoted as ƒ₂ now approximates the physical function ƒₚ.

The subsequent training step involves the forward computation of y=ƒ₂ (ƒ₁(x)) and the weights within ƒ₁ are trained using a backpropagation algorithm until convergence while the initially trained weights within ƒ₂ are not allowed to change. The number of weights within both ƒ₁ and ƒ₂ is sufficiently large to capture the statistical relations in the training datasets. The objective function used in the backpropagation algorithm for training both ƒ₁ and ƒ₂ may be a mean-squared-error function or any other measure of how accurately the parts of the present invention are able to predict the ground truth or training data.

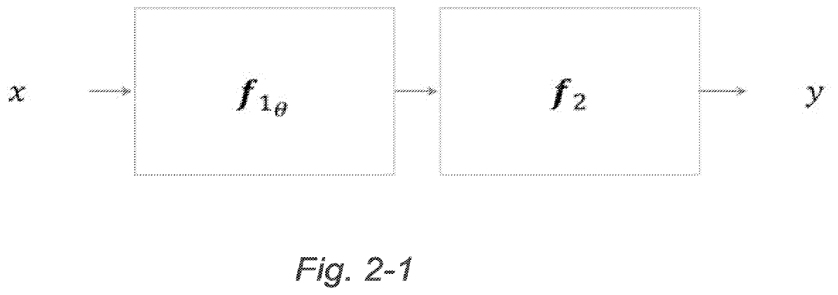

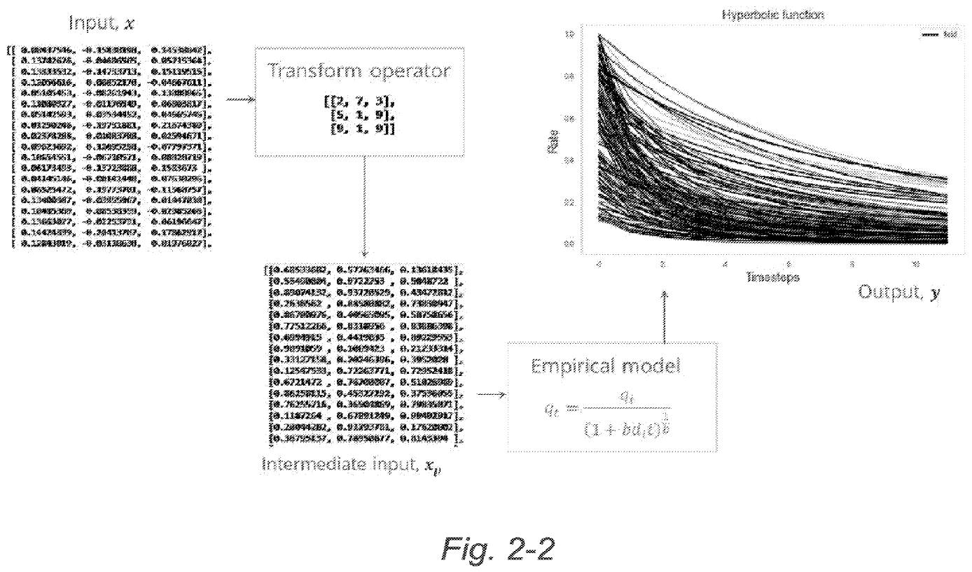

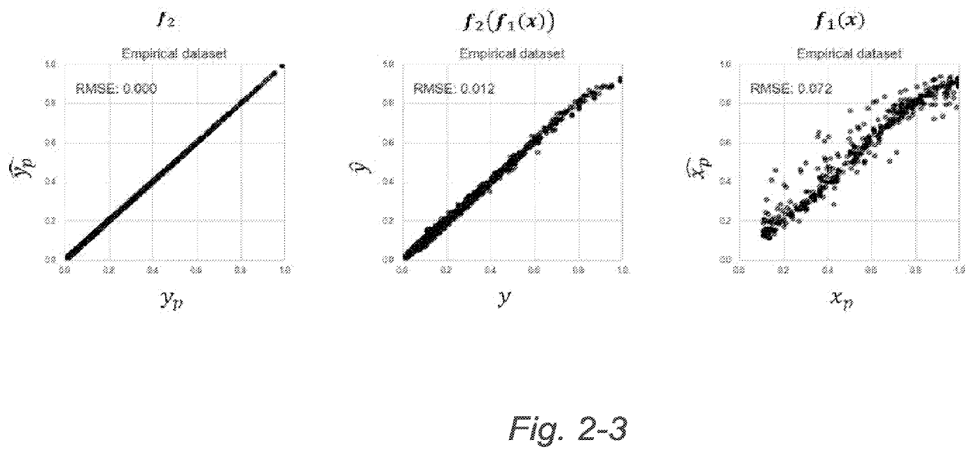

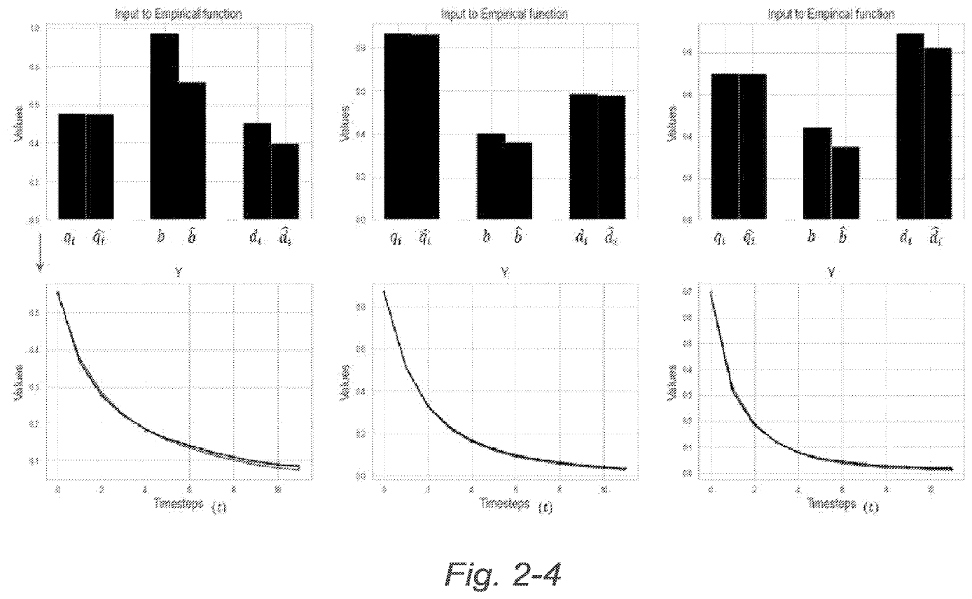

FIG. 1-2 depict a workflow to generate training data for the present invention where the illustrated “Empirical model” represents ƒₚ, the aforementioned arbitrary physical function. In this example, the empirical model is a hyperbolic function defined as qₜ=qᵢ/(1+bdᵢt)^{1/b}. The “Intermediate input” represents xₚ as the input into ƒₚ as a tuple of (qᵢ, b, dᵢ). In this example, the parameter t is arbitrarily chosen as a vector of real integers from 0 to 11. The output yₚ is calculated using each of the sampled tuples xₚ as yₚ=ƒ₂(xₚ) to collect a set of training data pairs representing the physical function where yₚ is qₜ. The parts ƒ₂ are trained as described earlier.

In the example shown in FIG. 1-2, following the complete training of ƒ₂, the subsequent training step for ƒ₁ proceeds as described earlier using the pairs of training data (x, y). In this motivating example, the input data x is generated by applying a “transform operator” on xₚ and the output data y corresponds to the same yₚ. FIG. 1-3 shows the performance of the present embodiment on a test dataset not seen in the training process. The first scatter plot shows that ƒ₂ in the proposed invention is able to accurately predict yₚ for any given xₚ, suggesting that ƒ₂ now has sufficiently represented the physical function ƒₚ. The second scatter plot shows that the proposed embodiment is able to accurately predict y for any given x. The third scatter plot shows transformation function learned by the function ƒ₁.

The bar plots in the first row of FIG. 1-4 show examples the original tuple (qᵢ, b, dᵢ) and their corresponding prediction (\hat{q}_{ι}, \hat{b}, [symbol] )). The following line plots in the second row of FIG. 1-4 show the original dataset y as scatter points, red line representing [symbol] , and green line representing ŷ. The present invention is able to represent both the physical function embedded in ƒ₂, the behavior of the other function in ƒ₁, and the final prediction of the neural network is given by the compounded function ƒ₂(ƒ₁(⋅)). The present invention conveniently incorporates physical information into neural network predictive models through selective training. The invention can improve predictive performance by including information from a vast dataset generated from physical functions into a neural network and can alleviate the issue of data paucity.

In a second embodiment, a method to combine physical functions into a neural network by backpropagation is provided. The method used multiple physical functions embedded in a neural network. In this example shown in FIG. 2-1, several fully-connected artificial neural network layers form ƒ₁_{_{θ}} (i.e., a first neural network component) and the subsequent ƒ₂ (i.e., a second neural network component) represents the embedded physical function. A fully-connected layer with a nonlinear activation function ƒ(⋅) is defined as Z=ƒ(W_{d}A+b_{d}) where A∈R^{N}^{_{b}}^{×N}^{ᵢ} denotes the input into the layer, N_{b} is the batch size of the input, Nᵢ is the size of the input, W_{d}∈R^{N}^{_{d}}^{×N}^{ᵢ} represents the weights to be trained, N_{d} is the number of hidden nodes of the fully-connected layer, and b_{d}∈R^{N}^{_{d}}^{×1} represents the bias term. The output of each fully-connected layer is denoted as Z. Several fully-connected layers are stacked to form ƒ₁_{_{θ}} where the training data input and output pairs are respectively denoted as x and y. The trainable weights within ƒ₁_{_{θ}} are represented as θ.

Referring now to the present invention shown in FIG. 2-1 in more detail, ƒ₂ represent the embedded physical function. Given an arbitrary physical function ƒ₂, the input into ƒ₂ is the output of the neural network layers represented as ƒ₁_{_{θ}}(x). A full forward computation of the predictive model is defined as y=ƒ₂ (ƒ₁_{_{θ}}(x)). The pairs of x and y are used as the training data to train the weights within ƒ₁_{_{θ}} using a backpropagation algorithm. During training, only the weights within ƒ₁_{_{θ}} are trained and there are no weights that need to be trained within the physical function ƒ₂. Using a backpropagation algorithm, the gradient information flows from the objective function through the physical functions by invoking the chain rule. The objective function can be defined as L_{θ}(x, y)=∥y−ƒ₂ (ƒ₁_{_{θ}}(x))∥²₂. The updates to the weights θ for any iteration i and learning rate α can be defined as θᵢ₊₁=θᵢ+α*δL/δθᵢ. The gradient δL/δθ can be calculated using a closed-form solution when available or approximated through finite-difference methods. The chain rule is invoked by calculating δL/δθ=δL/δƒ₁_{_{θ}}(x)*δƒ₁_{_{θ}}(x)/δθ. Once trained to convergence, the physical functions are embedded in the artificial neural network. The number of weights within ƒ₁ is sufficiently large to capture the statistical relations in the training datasets. The objective function used in the backpropagation algorithm for training the present invention may be the mean-squared-error function or any other measure of how accurately the present invention is able to predict the ground truth or training data.

FIG. 2-2 depict a workflow to generate training data for demonstration of the present invention where the illustrated “Empirical model” represents ƒ₂, the aforementioned arbitrary physical function. In this example, the empirical model is a hyperbolic function defined as qₜ=qᵢ/(1+bdᵢt)^{1/b}. The “Intermediate input” represents xₚ as the input into ƒ₂ as a tuple of (qᵢ, b, dᵢ). In this example, the parameter t is arbitrarily chosen as a vector of real integers from 0 to 11. The output y is calculated using each of the sampled tuples xₚ as y=ƒ₂ (xₚ) to collect a set of training data pairs representing the physical function where y is qₜ. In this motivating example, the input data x is generated by applying a “transform operator” on xₚ and the generated dataset consist of tuples of (x, xₚ, y). In this example shown in FIG. 2, the training step for the present invention proceeds as described earlier using the pairs of training data (x, y).

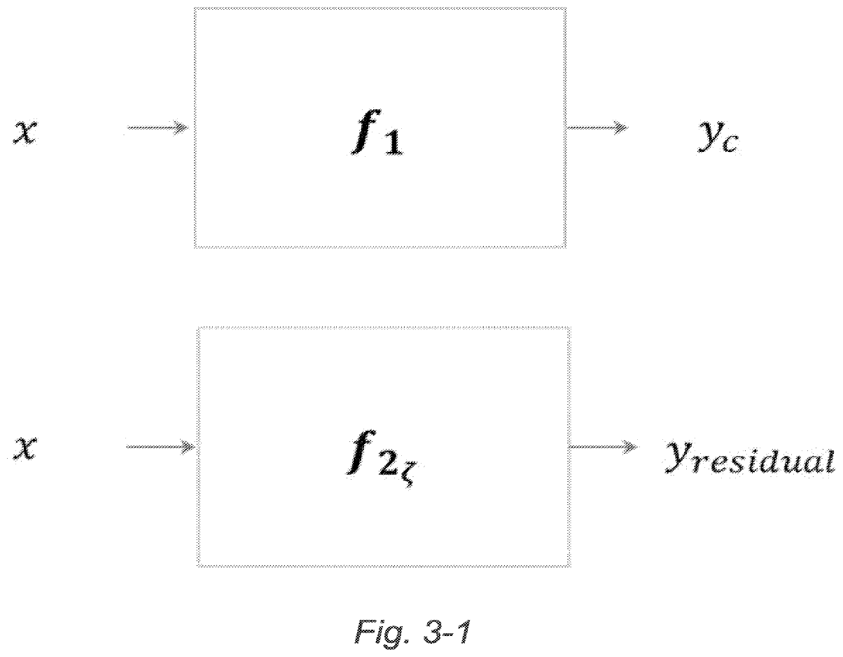

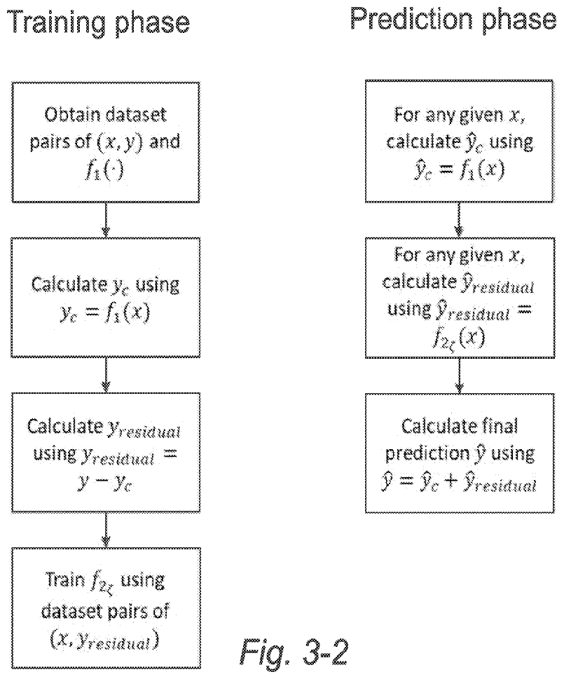

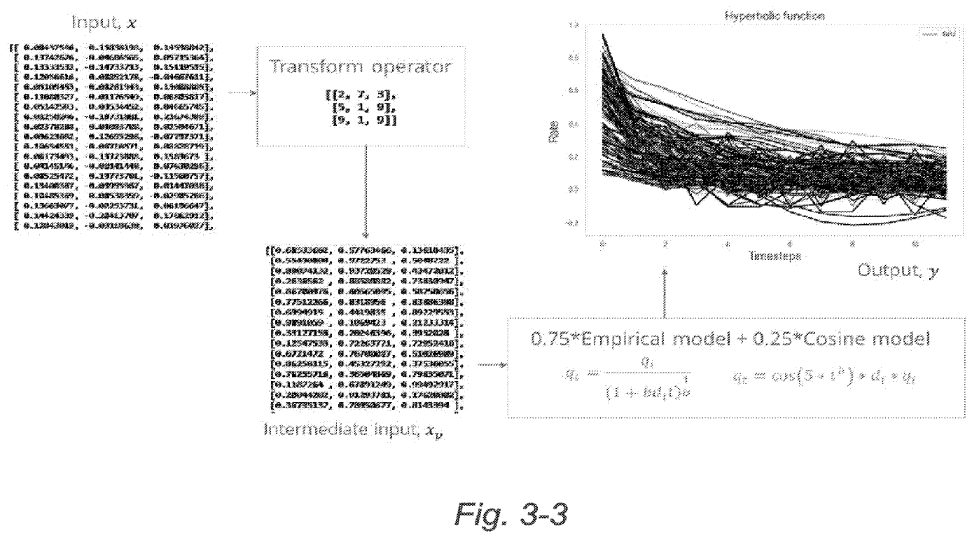

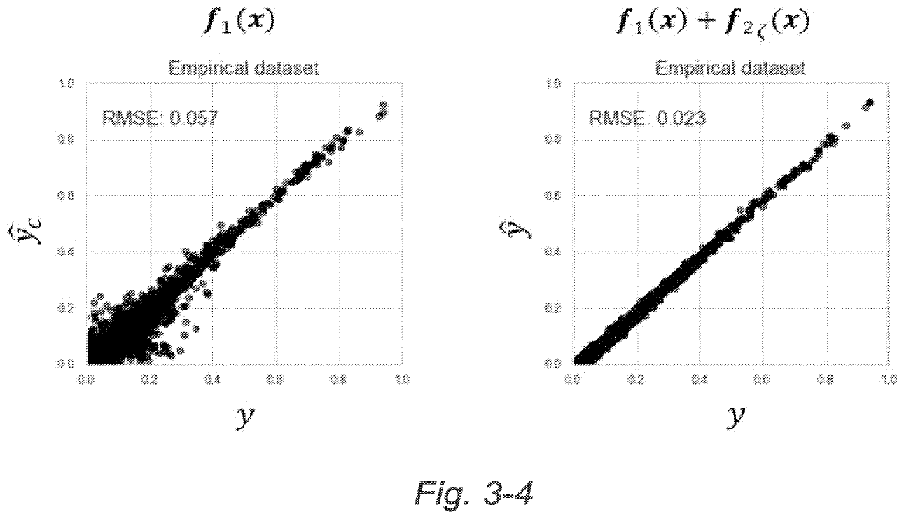

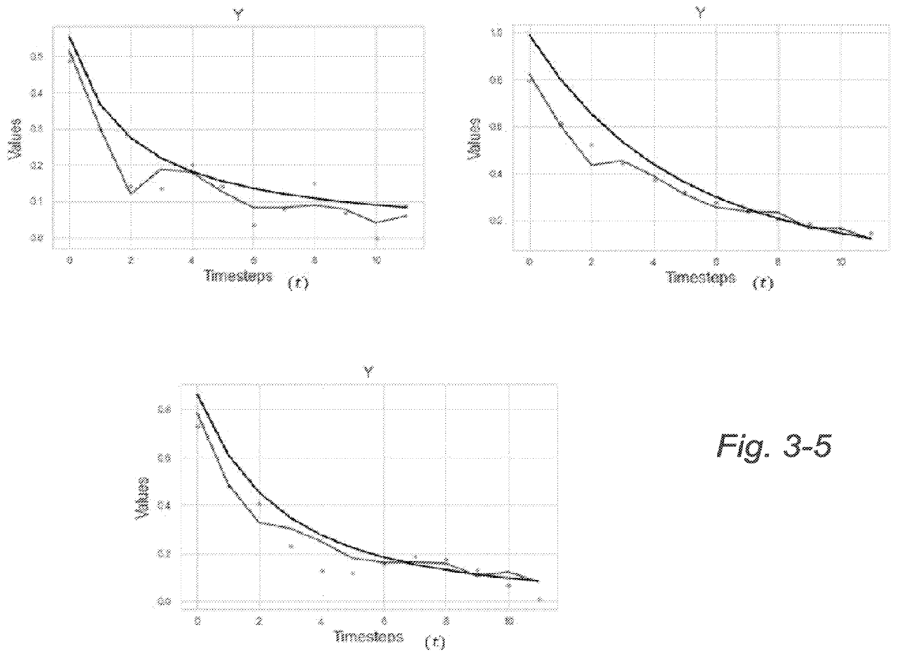

FIG. 2-3 shows the performance of the present invention on a test dataset not seen in the training process. The first scatter plot shows that ƒ₂ embedded in the proposed invention is able to perfectly predict y for any given xₚ, suggesting that the embedded ƒ₂ now perfectly represents the physical function ƒ₂. The second scatter plot shows that the proposed invention is able to accurately predict y for any given input x. The third scatter plot shows transformation function learned by the function ƒ₁.

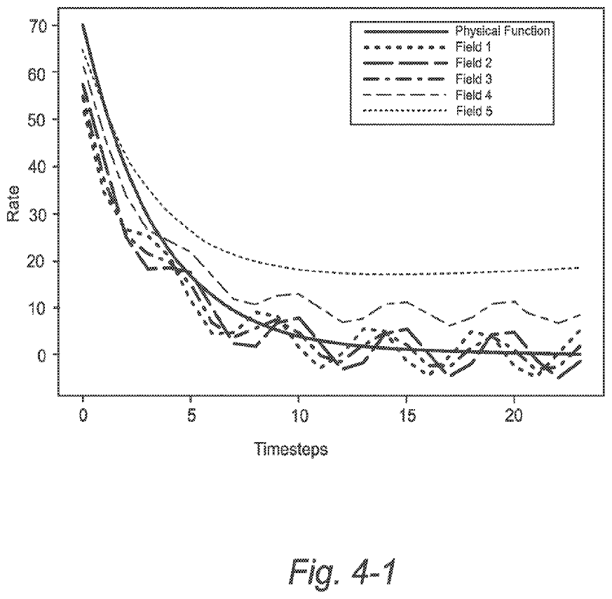

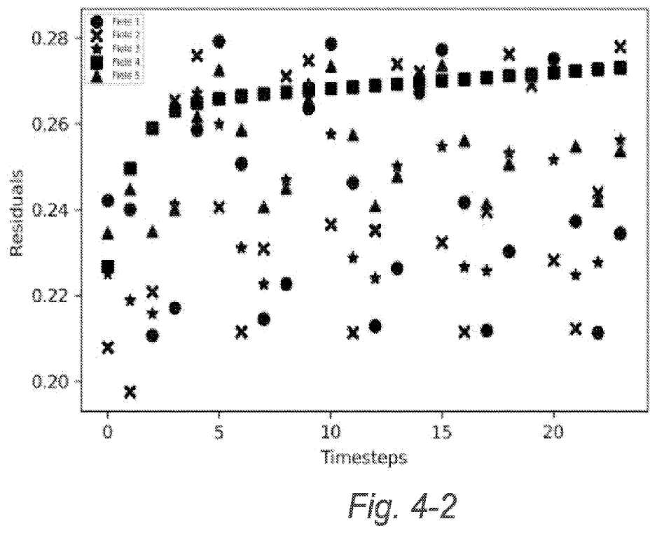

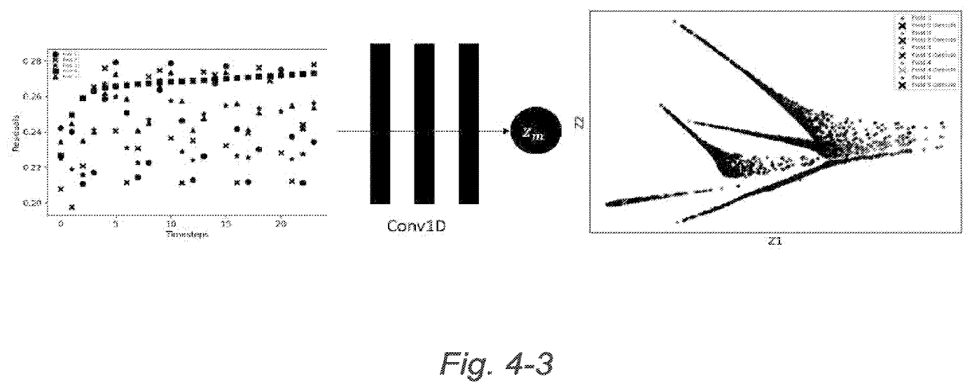

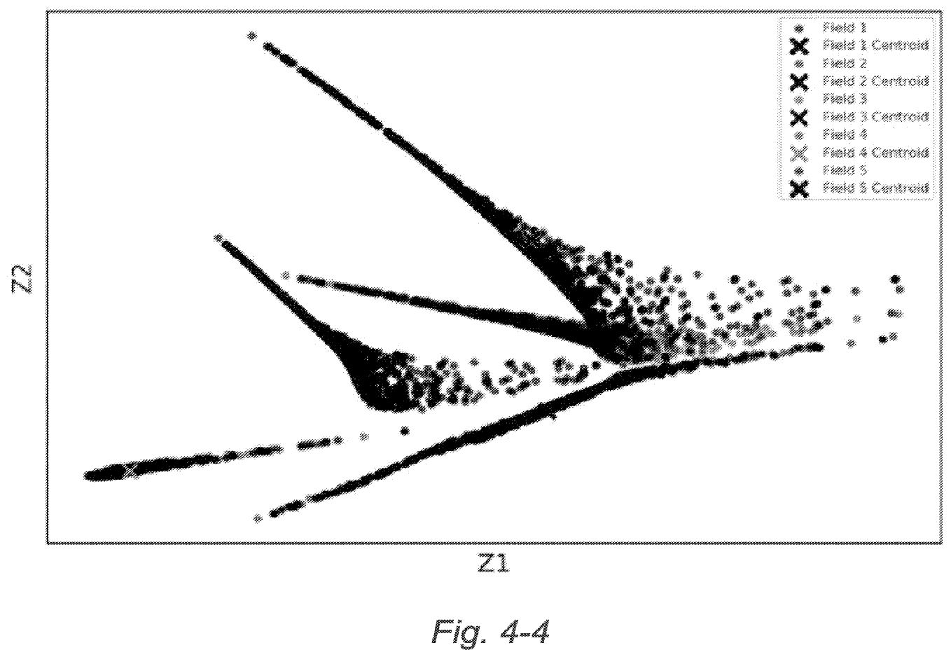

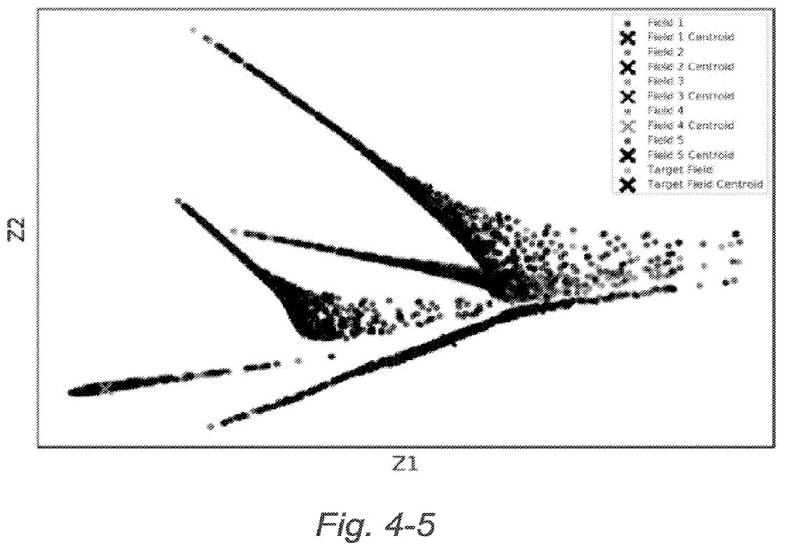

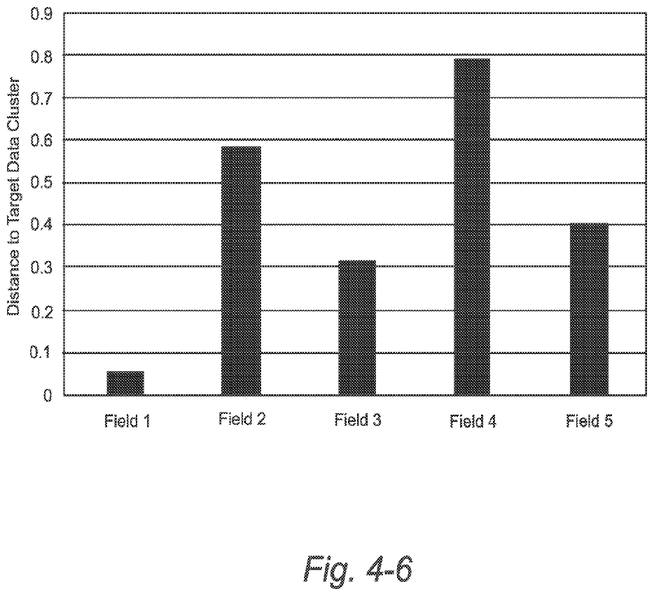

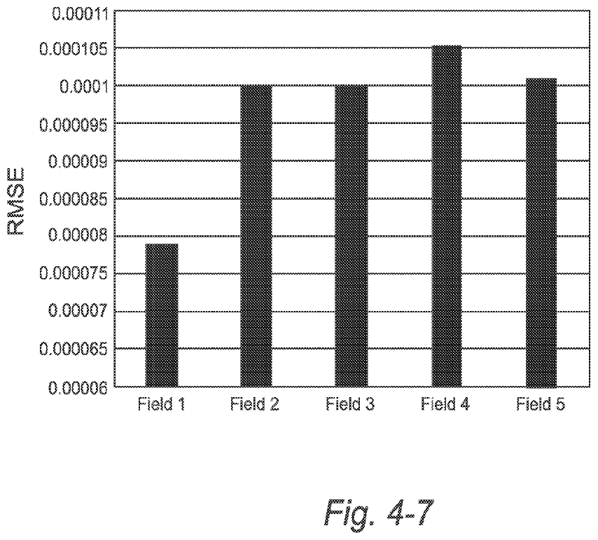

The bar plots in the first row of FIG. 2-4 show examples the original tuple xₚ=(qᵢ, b, dᵢ) and their corresponding prediction [symbol] =( [symbol] , \hat{b}, [symbol] ). The following line plots in the second row of FIG. 4 show the original dataset y as scatter points, red line representing [symbol] directly calculated from ƒ₂, and green line representing ŷ from the present invention. The present invention comprises of the physical function embedded in ƒ₂, the learned function ƒ₁, and the final prediction of the neural network is given by the compounded function ƒ₂(ƒ₁ (⋅)). The present invention conveniently embeds one or more physical functions into neural network predictive models through the backpropagation algorithm by invoking the chain rule. The invention can improve predictive performance by including the physical functions into a neural network and can alleviate the issue of data paucity and help reduce the number of weights in a neural network.

In a third embodiment, a method to improve physics-constrained neural network predictions using residual learning is provided. The method provides improved prediction for any given input x by augmenting the prediction y from a given physics-constrained neural network ƒ₁ (i.e., a first neural network component) with a predicted residual y_{residual} from another trained neural network ƒ₂_{_{ζ}} (i.e., a second neural network component). In the schematic shown in FIG. 3-1, several fully-connected artificial neural network layers form ƒ₂_{_{ζ}}. A fully-connected layer with a nonlinear activation function ƒ(⋅) is defined as Z=ƒ(W_{d}A+b_{d}) where A∈R^{N}^{_{b}}^{×N}^{ᵢ} denotes the input into the layer, N_{b} is the batch size of the input, Nᵢ is the size of the input, W_{d}∈R^{N}^{_{b}}^{×N}^{ᵢ} represents the weights to be trained, N_{d} is the number of hidden nodes of the fully-connected layer, and b_{d}∈R^{N}^{_{d}}^{×1} represents the bias term. The output of each fully-connected layer is denoted as Z. Several fully-connected layers are stacked to form ƒ₂_{_{ζ}} where the training data input and output pairs are respectively denoted as x and y_{residual}. The trainable weights within ƒ₂_{_{ζ}} are represented as ζ. Referring now to the invention shown in FIG. 3-1 in more detail, ƒ₂_{_{ζ}} represents the artificial neural network that learns to predict the residual y_{residual} for any given input x. The function ƒ₁ is assumed to be given and available. The output of function ƒ₁ is calculated for any given input x using y=ƒ₁(x).

FIG. 3-2 shows a workflow of the training phase for ƒ₂_{_{ζ}} and a workflow for the prediction phase to obtain the final prediction. Given the availability of a dataset pairs of (x, y) and a given physics-constrained neural network ƒ₁, the corresponding prediction y, from ƒ₁ is calculated as y_{c}=ƒ₁(x). As the physical functions embedded within ƒ₁ cannot fully represent the relationship between the input and output data pairs (x, y), the residual y_{residual} between y_{c} and the output data y can be calculated as y_{residual}=y−y_{c} for any given x. The pairs of x and y_{residual} are used as the training data to train the weights within ƒ₂_{_{ζ}} using a backpropagation algorithm until convergence. The number of weights within ƒ₂_{_{ζ}} is sufficiently large to capture the statistical relations in the training dataset. The objective function used in the backpropagation algorithm for training the present invention may be the mean-squared-error function or any other measure of how accurately the present invention is able to predict the ground truth or training data. In the subsequent prediction phase, for any given input x, the prediction ŷ_{c} from the physics-constrained neural network ƒ₁ is given as ŷ_{c}=ƒ₁(x). For any given input x, the prediction ŷ_{residual} from the trained neural network ƒ₂_{_{ζ}} is given as ŷ_{residual}=ƒ_{2ζ}(x). The final prediction y is calculated using ŷ=ŷ_{c}+ŷ_{residual}.

FIG. 3-3 depicts a workflow to generate training data for demonstration of the present invention where the illustrated “Empirical model”, “Cosine model”, and “Transform operator” together represent the relationship between the input and output data pairs (x, y). In this example, the empirical model is a hyperbolic function defined as qₜ=qᵢ/(1+bdᵢt)^{1/b} and the cosine model is a cosine function defined as qₜ=cos(5t^{b})dᵢqᵢ. A set of input x is randomly sampled and the linear transform operator is applied on the set of input x to obtain a set of intermediate input xₚ. The “Intermediate input” represents xₚ as the input into the hyperbolic and cosine functions as a tuple of (qᵢ, b, dᵢ). In this example, the parameter t is arbitrarily chosen as a vector of real integers from 0 to 11. The output y is calculated using each of the sampled tuples xₚ as a weighted sum such that y=0.75*qᵢ/(1+bdᵢt)^{1/b}+0.25*cos(5t^{b})dᵢqᵢ to collect a set of training data pairs (x, y). In this example shown in FIG. 3-3, a physics-constrained neural network ƒ₁ contains the specified hyperbolic function as an embedded physical function in the last layer of ƒ₁. This ƒ₁ is used as a motivating physics-constrained neural network that cannot fully represent the relationship between the input and output data pairs (x, y) as it does not have the cosine function embedded as well. The training step for the present invention proceeds as described earlier in FIG. 3-2 using the pairs of training data (x, y).

FIG. 3-4 shows the performance of the invention on a test dataset not seen in the training process. The first scatter plot shows that using the described motivating physics-constrained neural network ƒ₁ to obtain the prediction ŷ_{c} results in large residuals when compared to y, as ƒ₁ cannot fully represent the dataset. The second scatter plot shows the predictions ŷ=ŷ_{c}+ŷ_{residual}=ƒ₁(x)+ƒ₂(x) obtained from the invention where smaller error is observed as ƒ₂_{_{ζ}} learns the residuals that are augmented to the predictions from ƒ₁ to constitute the final predictions. The following line plots in FIG. 3-5 show the original dataset y as scatter points, red line representing ŷ_{c} directly calculated from ƒ₁, and green line representing ŷ from the present invention. The present invention results in a final prediction that combines the prediction from the physics-constrained neural network with the predicted residual from the additional neural network component.

In a fourth embodiment, a method to identify and rank source models for transfer learning is provided. The method uses multiple potential source fields with different factors affecting production leading to different characteristics to the production profiles. FIG. 4-1 shows a sample dataset used to demonstrate the methodology. It depicts an underlying physical function represented by the exponential decline function qₜ=qᵢe^{-Dit} and different potential source datasets each with their own unique characteristics. The input parameters of the underlying functions are qᵢ and Dᵢ and the output is the production curve, qₜ. The additional characteristics are unique to each dataset in order to mimic different possible factors affecting different fields during production. The datasets will be available from mature fields that have many wells drilled and completed in them. While the exponential decline function is assumed to be the common underlying physics for all of the fields.

The first step is to isolate the unique characteristic of these multiple datasets, this is done by subtracting the exponential decline function (or any physical function deemed appropriate) from the different sets of field data to obtain the residuals rₜ. The residuals shown in FIG. 4-2, illustrate that a visual comparison will not be able to distinguish the different fields.

FIG. 4-3 shows the schematic of an auto encoder type neural network, that is used to extract the features from the residual data in order to make them more distinguishable in a latent space. The auto encoder consists of an encoder and decoder network that are jointly trained.

The network takes in the original residual data (rₜ) as the input, passes it through a series of successive layers and generates a low-dimensional representation in the form of latent variables, zₘ∈R^{N}^{ₘ}^{×1}. Where Nₘ, is the size of the latent space vector. The encoder is composed of the following repeating layers, a one-dimensional (1D) convolutional function (conv1D), followed by a non-linear activation leaky-ReLU function (lrelu) and lastly a one-dimensional pooling (down-sampling) operation (pool). The gradual reduction in dimensionality of the input is accomplished by these successive temporal pooling functions to obtain the desired compact representation as latent variables. Once the encoder generates the representative low dimensional latent variables zₘ, they are used as inputs to the decoder. The decoder reshapes the latent variables and gradually up-samples it to produce a reconstruction \hat{q}ₜ, in its full dimension. However, we are only interested in the latent variables and not the reconstructions, hence the model is truncated after it is trained to only the encoder.

The projections of the production data from different source fields is obtained by the encoder and is shown in FIG. 4-4. It is evident that fields with similar properties tend to cluster together and fields with distinct characteristics are further apart in the latent space. Additionally, the centroids of all the clusters obtained are determined.

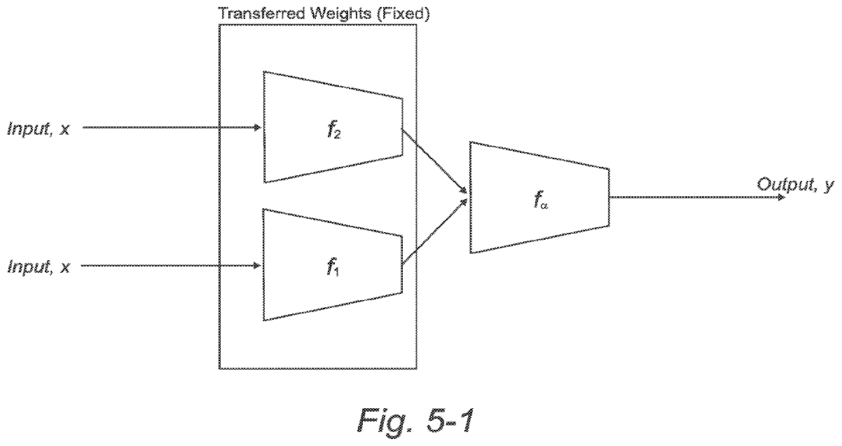

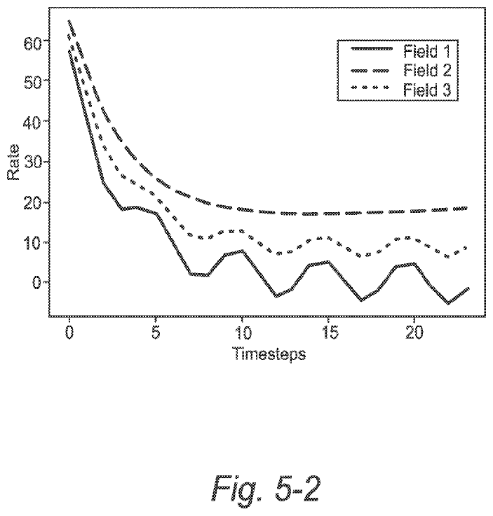

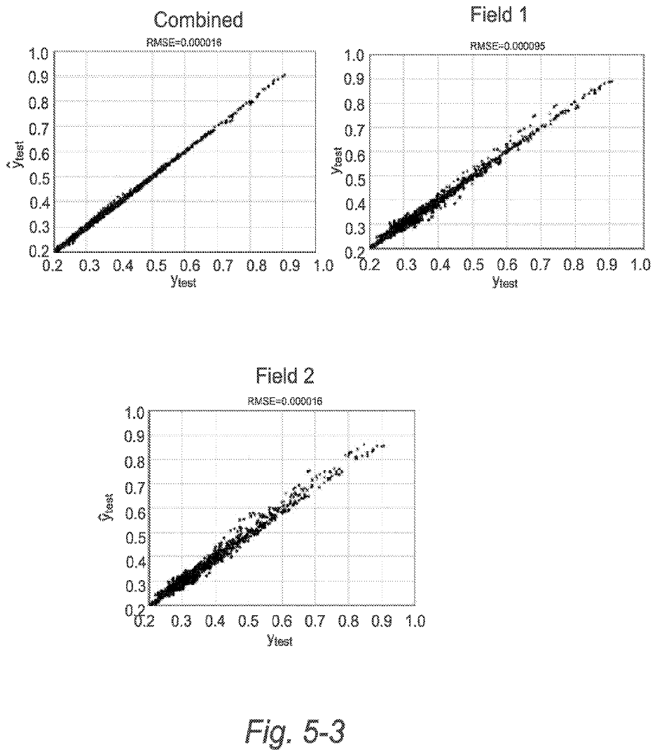

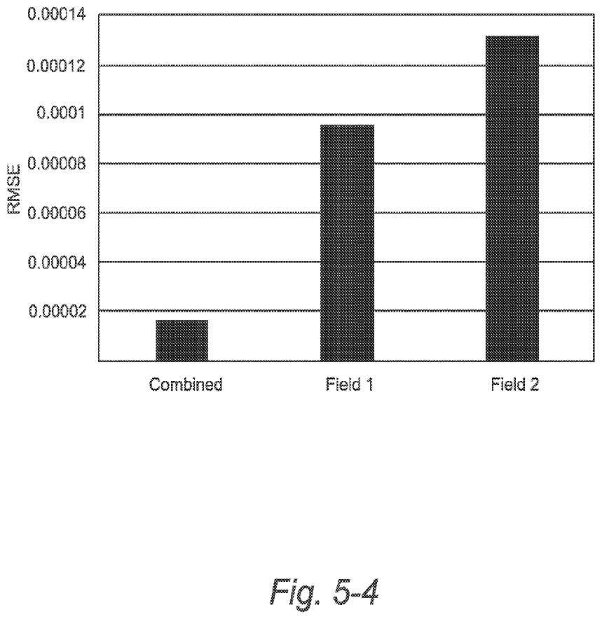

In order to determine the best field datasets to be used for transfer learning, the production data from the target field is used as input through the same auto encoder and its low dimensional projections are viewed in the latent space. For simplicity, a target field similar to Field 1 is used to illustrate the example. FIG. 4-5 shows the projections of the target field in the same latent space as the projections of the multiple source fields.

Once the projections and their respective centroids are obtained, an appropriate metric is selected to determine which source models are the best. In this case Euclidean distance is the metric selected, but depending on the type of clustering and task different metrics can be used. FIG. 4-6 shows the Euclidean distance of the centroid of the target dataset to different source datasets. The source datasets that are closer to the target dataset contain more relevant knowledge are better candidates for transfer learning. However, the clusters of source datasets that are further away may cause negative transfer as they are less relevant. It can be seen that Field 1 is the closest cluster to the cluster of the target dataset and the model trained with it would be the best candidate as a source model to be transferred, while Field 4 is the furthest away and would not be ideal for transfer learning. This allows for the ranking of different source models. Using the metric, Field 1 is the highest rank dataset, while Field 2 would be the next highest ranked dataset, and both could be selected as potential source models for transfer learning.

This is confirmed in FIG. 4-7, which shows the performance (RMSE) of transfer learning when data from each field is used to train a source model and then transferred to the target field where a model is trained with the target data while keeping the source model fixed. It is evident that Field 1, whose cluster in the latent space was the closest to the target field, is the best dataset to use to train the source model to be transferred. On the other hand, Field 4 has the worst performance and is also the dataset whose latent space is furthest. If needed the next few highest ranked datasets could also be included during retraining of the target dataset and checked if they improve the performance of the model.

In a fifth embodiment, a method to aggregate source models predictions for transfer learning is provided. The method uses multiple source models trained on different datasets assembled into one network in order to facilitate transfer learning when the target data may be related to multiple datasets. In this example shown in FIG. 5-1, a fully-connected layer with a nonlinear activation function ƒ(⋅) is defined as Z=ƒ(W_{d}A+b_{d}) where A∈R^{N}^{_{b}}^{×N}^{ᵢ} denotes the input into the layer, N_{b} is the batch size of the input, Nᵢ is the size of the input, W_{d}∈R^{N}^{_{b}}^{×N}^{ᵢ} represents the weights to be trained, N_{d} is the number of hidden nodes of the fully-connected layer, and b_{d}∈R^{N}^{_{d}}^{×1} represents the bias term. The output of each fully-connected layer is denoted as Z. Several fully-connected layers are stacked to form both ƒ₁, ƒ₂, ƒₐ (i.e., multiple neural network components) where the training data input and output pairs are respectively denoted as x and y. Referring now to the present invention shown in FIG. 5-1 in more detail, ƒ₁, ƒ₂, represent parts of the neural network that are to represent the two different networks trained on two different source datasets. For each network, xᵢ is sampled from the respective dataset and the corresponding output yᵢ is calculated as yᵢ=ƒᵢ(xᵢ). The pairs of xᵢ and yᵢ are used as the training data to train the weights within ƒ₁ and ƒ₂ using a backpropagation algorithm, where i refers to the different source datasets. The number of weights within both ƒ₁ and ƒ₂ is sufficiently large to capture the statistical relations in the training datasets. Specifically, in the initial training step, the forward computation is yᵢ=ƒᵢ(xᵢ) where once convergence is reached, the parts of the neural network denoted as ƒ₁ and ƒ₂ now store information different from each other but both relevant to the target task.

The subsequent training step involves the forward computation of yₜ=ƒₐ(ƒ₁(xₜ), ƒ₂(xₜ)) and the weights within fa (i.e., a final network component) are trained using a backpropagation algorithm until convergence while the initially trained weights within ƒ₁ and ƒ₂ are not allowed to change. The number of weights in fa is sufficient to capture the statistical relations in the target training dataset and the outputs from the two source models. The objective function used in the backpropagation algorithm for training ƒ₁, ƒ₂ and fa may be mean-squared-error function or any other measure of how accurately the parts of the present invention are able to predict the ground truth or training data.

FIG. 5-2 depicts a sample of the different datasets used in this example. The source datasets are labeled as Field 1 and Field 2, and are represented as a form of exponential decline function qₜ=qᵢe^{-Dit} with some additions to distinguish them. The target dataset is listed as a combination of the features affecting Field 1 and Field 2. The input data to the models is x as a tuple of (qᵢ, Dᵢ). In this example, the parameter t is arbitrarily chosen as a vector of real integers from 0 to 24. The output yᵢ is calculated using each of the sampled tuples xᵢ as y₁=ƒ₁(x₁) and y₂=ƒ₂(x₂), to collect a set of training data pairs representing the source datasets where y; is qₜ. The parts ƒ₁ and ƒ₂ are trained as described earlier.

In this example shown in following the complete training of ƒ₁ and ƒ₂, the subsequent training step for ƒₐ proceeds as described earlier using the pairs of training data (x, y). The initial input x of the target dataset is entered into both source models. The outputs of the two selected source models are used as in input to ƒₐ. FIG. 5-3 shows the scatter plots of the results when only individual models are selected one at a time to be transferred (Field 1 and Field 2) and when the source models (ƒ₁, ƒ₂) are used along with ƒₐ (combined). The presented invention performs (combined model) performs better when only the models are available for transfer and not the datasets as long as both source models are relevant.

Referring to FIG. 5-4, the bar plots summarize the results by comparing the RMSE of the three models. The combined model has the least RMSE and shows that this invention does allow combining relevant multiple models into one aggregated model to facilitate transfer learning as opposed to using individual models which may provide subpar results.

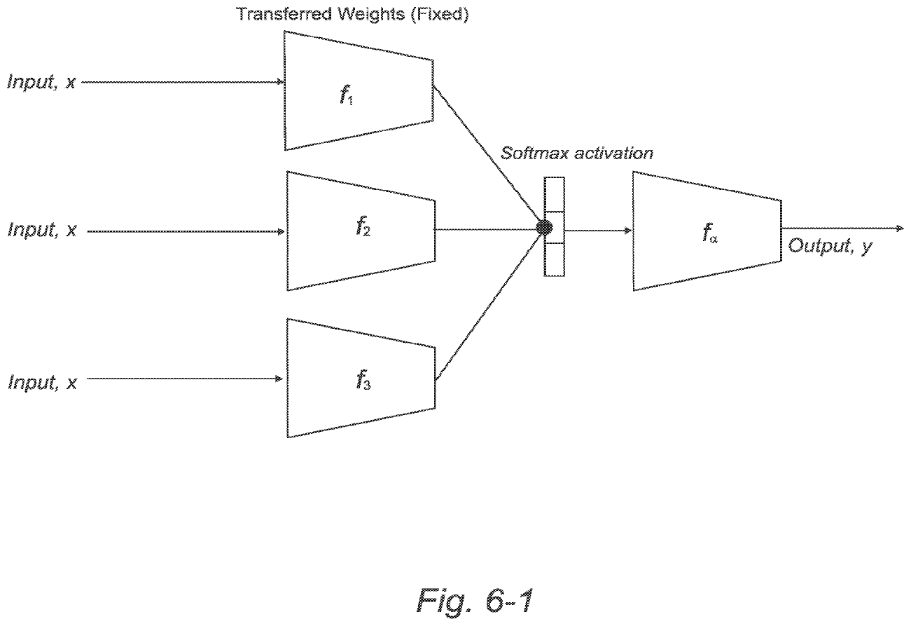

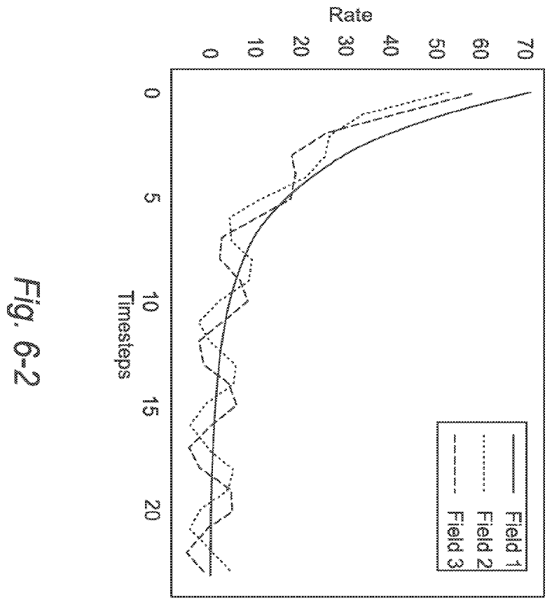

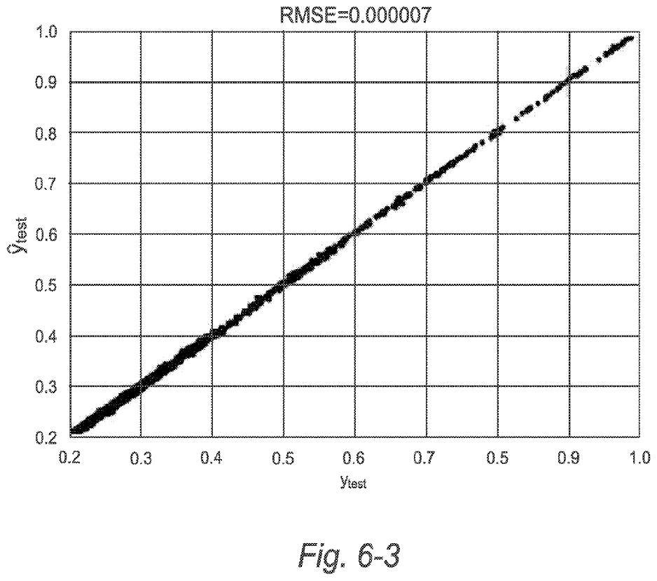

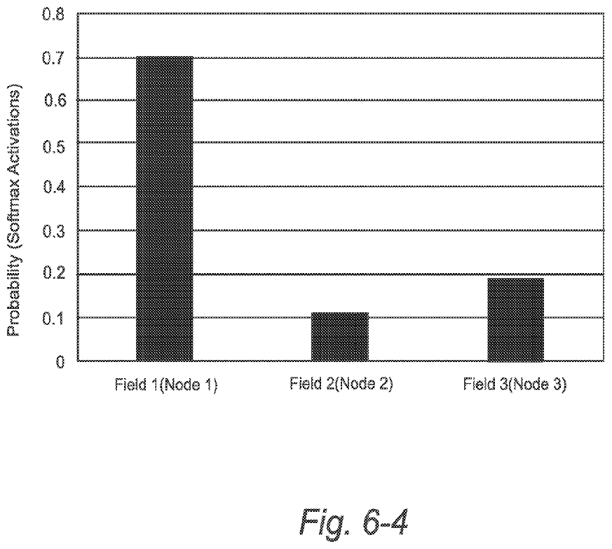

In a sixth embodiment, a method to rank probabilities of source models for transfer learning is provided. The method uses multiple source models trained on different datasets assembled into one network in order to facilitate transfer learning when the target data may be related to multiple datasets. In this example shown in FIG. 6-1, a fully-connected layer with a nonlinear activation function ƒ(⋅) is defined as Z=ƒ(W_{d}A+b_{d}) where A∈R^{N}^{_{b}}^{×N}^{ᵢ} denotes the input into the layer, N_{b} is the batch size of the input, Nᵢ is the size of the input, W_{d}∈R^{N}^{_{b}}^{×N}^{ᵢ} represents the weights to be trained, N_{d} is the number of hidden nodes of the fully-connected layer, and b_{d}∈R^{N}^{_{d}}^{×1} represents the bias term. The output of each fully-connected layer is denoted as Z. Several fully-connected layers are stacked to form both ƒ₁, ƒ₂, ƒ₃, ƒₐ (i.e., multiple neural network components) where the training data input and output pairs are respectively denoted as x and y. Referring now to the present invention shown in FIG. 6-1 in more detail, ƒ₁, ƒ₂, ƒ₃ represent parts of the neural network that are to represent the three different networks trained on three different source datasets. For each network, xᵢ is sampled from the respective dataset and the corresponding output yᵢ is calculated as yᵢ=ƒᵢ(xᵢ). The pairs of xᵢ and yᵢ are used as the training data to train the weights within ƒ₁, ƒ₂ and ƒ₃ using a backpropagation algorithm, where i refers to the different source datasets. The number of weights within both ƒ₁, ƒ₂ and ƒ₃ is sufficiently large to capture the statistical relations in the training datasets. Specifically, in the initial training step, the forward computation is yᵢ=ƒᵢ(xᵢ) where once convergence is reached, the parts of the neural network denoted as ƒ₁, ƒ₂ and ƒ₃ now store information different from each other and possibly relevant to the target task.

The subsequent training step involves the forward computation of yₜ=ƒₐ (ƒ₁(xₜ), ƒ₂(xₜ), ƒ₃(xₜ)) and the weights within ƒₐ (i.e., a final neural network component) are trained using a backpropagation algorithm until convergence while the initially trained weights within ƒ₁, ƒ₂ and ƒ₃ are not allowed to change. The number of weights in ƒₐ is sufficient to capture the statistical relations in the target training dataset and the outputs from the two source models. The first layer of ƒₐ uses a SoftMax activation function before being mapped to the final output vector. The layer with the SoftMax activation is designed such that the number of hidden nodes is the same as the number of source models used during retraining. This way the activations from the layer can be extracted to determine the probabilities of the different source models relative to the target dataset. The objective function used in the backpropagation algorithm for training ƒ₁, ƒ₂, ƒ₃ and ƒₐ may be mean-squared-error function or any other measure of how accurately the parts of the present invention are able to predict the ground truth or training data.

FIG. 6-2 depicts a sample of the different datasets used in this example. The source datasets are labeled as Field 1 is represented as a form of exponential decline function qₜ=qᵢe^{-Dit}. Field 2 has an additional sine function and Field 3 has an additional cosine function. The target dataset is the same as the data from Field 1. The input data to the models is x as a tuple of (qᵢ, Dᵢ). In this example, the parameter t is arbitrarily chosen as a vector of real integers from 0 to 24. The output yᵢ is calculated using each of the sampled tuples xᵢ as y₁=ƒ₁ (x₁), y₂=ƒ₂ (x₂), and y₃=ƒ₃(x₃), to collect a set of training data pairs representing the source datasets where yᵢ is qₜ. The parts ƒ₁, ƒ₂ and ƒ₃ are trained as described earlier.

In this example shown in following the complete training of ƒ₁, ƒ₂ and ƒ₃, the subsequent training step for ƒₐ proceeds as described earlier using the pairs of training data (x, y). The initial input x of the target dataset is entered into the source models. The outputs of the three selected source models are used as in input to ƒₐ. FIG. 6-3 shows the scatter plots of the final results when the aggregated network is trained on the target dataset.

Referring to FIG. 6-4, the bar plots summarize the results by comparing the average activations for all the predictions from the test dataset. The probabilities listed from each of the hidden nodes is related to the probabilities of each of the selected models. The average activations of the first node has the highest probability, which means the model associated with it has the highest probability of being the correct source model for the current data set. The second and third nodes correspond to models that are not as closely related to the target dataset and hence report lower probabilities. This workflow allows a data driven model to determine which source models are the most accurate predictors to be transferred to a target dataset.

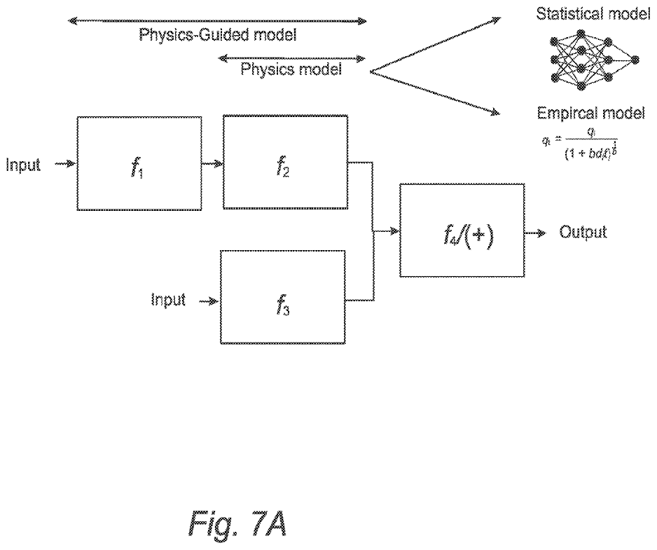

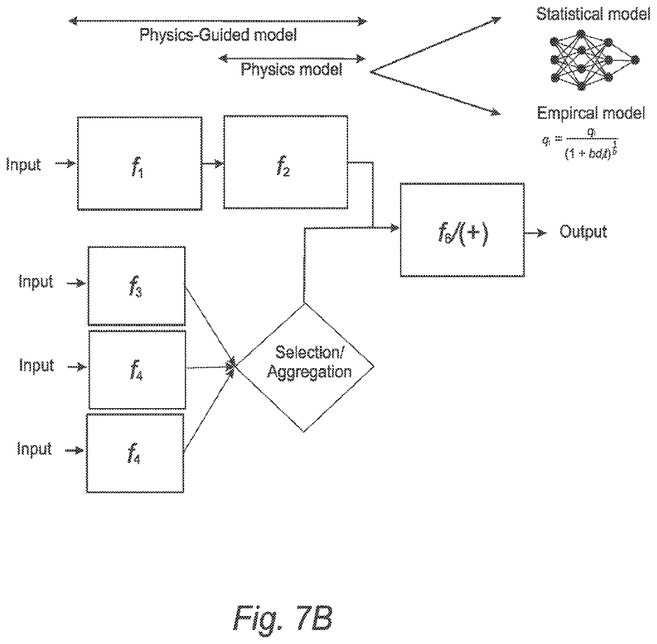

FIGS. 7A and 7B generalize one or more of the embodiments of FIGS. 1 to 6 described above. Referring to FIG. 7A, components f₁ and f₂ are used to construct a physics-guided model. Component f₂ provides a physics model (e.g., a simulator for oil production from hydraulically fractured wells) that can be a statistical model or an empirical mode. Components f₁ and f₂ can each be represented by one or more neural networks. In a refinement, f₂ is directly embedded into the neural network as custom computation layers to serve as the prior knowledge of physical dynamics. For a statistical model, the associated neural networks can be sufficiently large to capture statistical relations in the training datasets. In a refinement, statistical model can be trained on data from a simulator. In order to compensate for parameters from the system being modeled (e.g., an oil field) that cannot be adequately modeled, the f₁ component is provided before f₂. Typically, the physics based model is incomplete because we don't have a complete understanding of the underlying physics. Therefore, we can improve prediction by adding a residual network referred to as f₃. The output of f₃ is combined with the output of f₂ to give to a final prediction that matches observations from target physical system. Component f₃ corrects the predictions from f₁ and f₂ when it passes through component f₄. Component f₃ captures whatever the physical base model cannot predict accurately. It accomplished this by being trained on biases (e.g., differences from output of the combination f₁ and f₂ and the measured correct values). Component f₄ can be a neural network or a function that combines the outputs of f₂ and f₃. In a refinement, component f₄ can simply add the outputs of f₂ and f₃. The frameworks described herein are made with the idea of doing transfer learning such that the amount of data needed to model a new given physical system (e.g., a field is reduced). Although the trained components f₁ and f₂ may be incomplete, it is believed that they capture some true aspects of a new physical system to be studied. Since component f₃ is purely data driven it is not known if component f₃ is perfect for a new physical system. The workflow of FIG. 7B addresses this issue by providing residual networks (e.g, f₃, f₄, and f₅) which are trained with residual data from a plurality of physical systems.

In some embodiments, the general problem formulation, including its input/output and relevant notations is defined as follows. Given an observed dataset of N_{field} systems (e.g, N_{field} producers from an unconventional reservoir), the system properties (e.g., formation, fluid, and completion parameters) are defined as x, the historical production data as d, and the corresponding control trajectories as u. Let Nₓ be the length of feature vector x and Nₜ be the length of time-series d and u. We define N_{ƒ} as a parameter that denotes the dimension of the time-series production data, where N_{ƒ}=1 denotes univariate time-series (one phase) and N_{ƒ} >1 denotes multivariate time-series (multiphase) where the extension of multivariate formulation from the univariate formulation is mathematically straightforward. The problem of data-driven forecasting (e.g., production forecasting) can be formulated as d=ƒ(x, u), where ƒ(⋅) is a forecast function (i.e., model) that takes an input tuple (x, u) to output d. In a black-box data-driven production forecasting method, the forecast model ƒ(⋅) is tasked with learning (i) the temporal trends in the time-series data, (ii) the mapping between the temporal trends and system properties (e.g., well properties), and (iii) the mapping between the temporal trends and the control trajectory. With a trained ƒ(⋅), for any given test input tuple (e.g., representing a newly drilled well with limited or no observed initial production responses), the production forecast is obtained by computing \hat{d}=f(x, u). In the following subsections, the physics-constrained neural network formulation and two implementation approaches (i.e., statistical and explicit) are discussed. Subsequently, a new Physics-Guided Deep Learning (PGDL) model is introduced and elaborated on how the residual learning approach can be combined with physics-constrained models for improved production prediction.

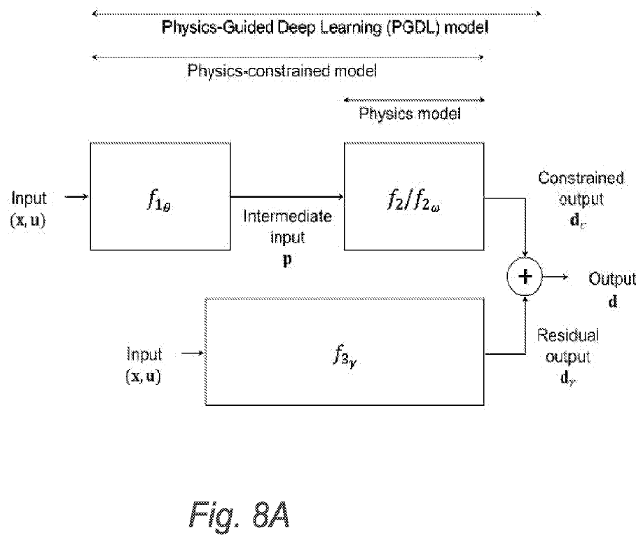

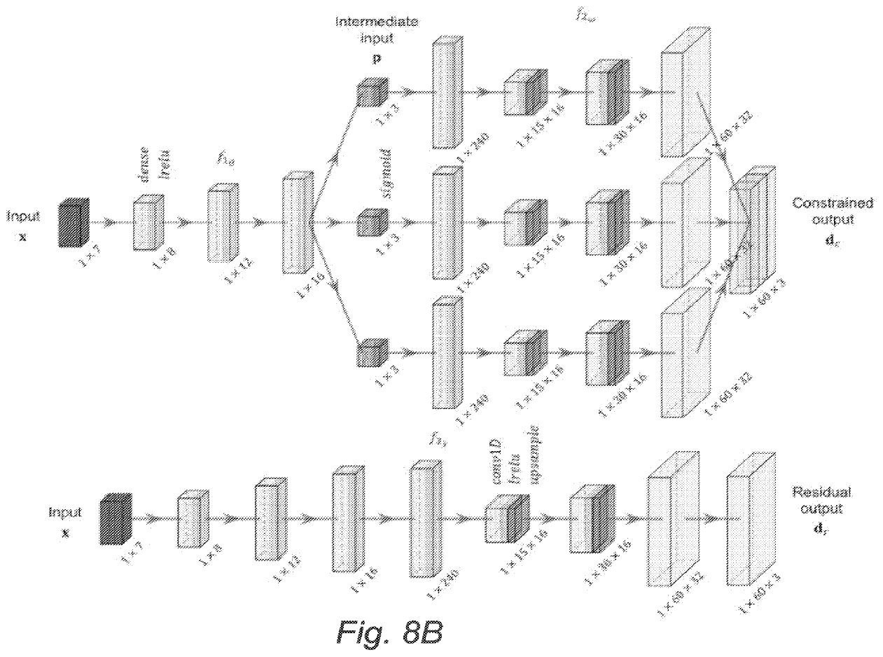

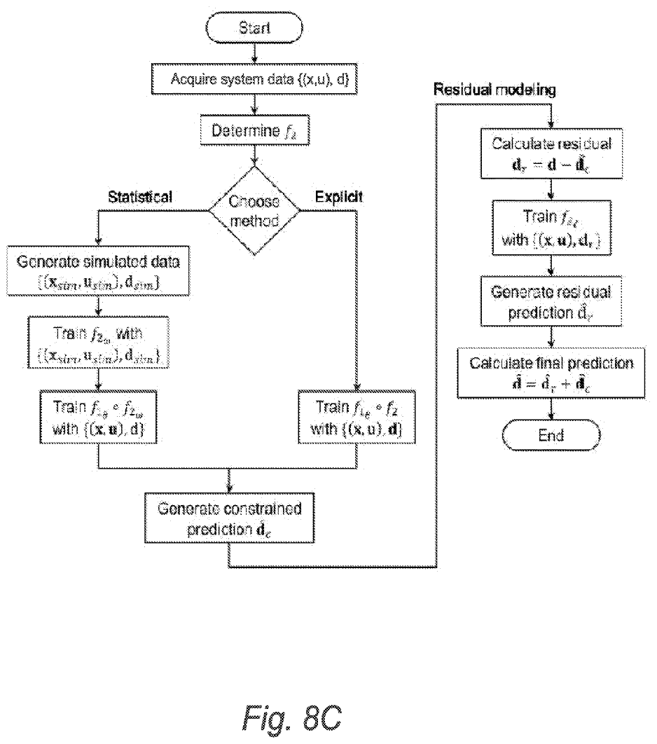

Physics-constrained neural network. In a gray-box production forecasting method, the existence of a physics-based model ƒ₂ that is directly embedded into the neural network as custom computation layers to serve as the prior knowledge of physical dynamics is assumed. A statistical proxy representation of the physics-based model is denoted as ƒ_{2ω} where ω represents the lumped trainable parameters. Specifically, as illustrated in FIG. 8A, a physics-constrained neural network model is a composition of ƒ₁_{_{θ}} (where θ represent the lumped trainable parameters) and ƒ₂ (as the explicit approach ƒ_{1ζ}∘ƒ₂) or ƒ_{2ω} (as the statistical approach ƒ_{1θ}∘ƒ_{2ω}). For a physics-constrained neural network model, the problem formulation now becomes d_{c}=ƒ₂ (ƒ_{1ζ}(x, u)) or d_{c}=ƒ_{2ω}(ƒ_{1ζ}(x, u)) where d_{c} represents the physically-constrained univariate or multivariate time-series output (i.e., production rates versus time). With a trained ƒ_{1θ}, for any given test input tuple, the operation \hat{p}=ƒ_{1θ}(x, u) results in intermediate variables \hat{p} that can be used as input for the physics-based model (i.e., as [symbol] =ƒ₂(\hat{p}) or [symbol] =ƒ_{2ω}(\hat{p}). The component ƒ_{1θ} enables the transformation of a wide variety of input features into vectorized input parameters that the physics-based model can accept. The neural network architecture of the proposed physics-constrained model can be composed of several fully-connected regression layers and one-dimensional (1D) convolutional layers. A fully-connected layer (denoted as dense) with an activation function ƒₐ(·) is simply defined as

$$Z = {f}_{a} ( {W}_{d} A + {b}_{d} )$$

where A∈ [symbol] denotes the input into the layer, N_{b} is the batch size of the input, Nᵢ is the size of the input, W_{d}∈ [symbol] represents the weights to be learned, N_{d} is the number of hidden nodes of the dense layer, and b_{d}∈ [symbol] represents the bias term. Leaky-ReLU (denoted as lrelu) is used as the element-wise activation function and for any arbitrary variable z is defined as

$${f}_{a} ( z ) = max ( z , α z ) , α ∈ ( 0 , 1 )$$

where α is an arbitrary parameter from 0 to 1 (e.g., 0.3 is a typical default value), stacked fully-connected layers can approximate complex functions and allow the model to learn a detailed nonlinear mapping between the input and output. Several dense layers can be used for ƒ_{1θ} where Nᵢ corresponds to the total length (i.e., Nₓ+Nᵢ) of the vectorized input tuple of x and u. In a refinement, a sigmoid activation function can be applied on the last layer of ƒ_{1θ} to bound (i.e., scale) its output values between zero and one to agree with the ranges of input values into the subsequent component ƒ_{2ω}or ƒ₂. The neural network model's learning capacity (i.e., amount of trainable parameters) is primarily affected by the number of hidden nodes within each layer Na and the number of layers to stack (i.e., depth of the neural network). The selection of optimal model hyperparameters can be made using an optimatization technique such as the grid search tuning technique that begins with small potential values and incrementally increases the values until no further increase in training and validation performance is observed. This process will ensure that the model can effectively fit the training data without inducing any form of underfitting or overfitting. The stacked dense layers architecture is the best for ƒ_{1θ}. Every node in each layer is connected to every node in another layer in this architecture, while the input tuple (x, u) does not have any local structures.

Statistical approach. The statistical approach to embed a physics-based model involves the trainable component ƒ_{2ω} as a proxy model that is trained using a simulated dataset (denoted with the subscript sim) generated from the physics-based model ƒ₂. Specifically, letting Nₛᵢₘ be the number of simulated data points, Nₛᵢₘ tuples of (xₛᵢₘ, uₛᵢₘ) are sampled from relevant physical and operating ranges and are fed into the physics-based model ƒ₂ to yield the time-series dₛᵢₘ by computing dₛᵢₘ=ƒ₂(xₛᵢₘ, uₛᵢₘ). Note that while the statistical approach offers more flexibility, especially when ƒ₂ is complex, the computational overhead associated with running forward simulations may be significant, particularly when the tuples (xₛᵢₘ, uₛᵢₘ) cover a broad range of values. Since the simulated data dₛᵢₘ ∈ [symbol] can be univariate or multivariate time-series of length N, with local temporal structures and temporally invariant features, ƒ_{2ω} can be constructed using one-dimensional (1D) convolutional layers. A decoder-style architecture composed of several main layers can be adopted for ƒ_{2ω} where each layer consists of convolutional function (denoted as conv1D and whose output is color-coded in FIG. 8B), leaky-ReLU (Rectified Linear Unit) non-linear activation function (lrelu) and an upsampling function (upsample). The input parameters p∈ [symbol] (representing tuples of (xₛᵢₘ, uₛᵢₘ)) are gradually upsampled (by repeating each temporal step along the time axis) to obtain a reconstruction of dₛᵢₘ. To reduce kernel artifacts from the upsampling operations, increase the dimension by 2 between each layer. Note that while a fully-connected layer can be used instead of a convolutional layer, the latter represents complex nonlinear systems using significantly reduced parameters through weight sharing (kernels) and by taking advantage of local spatial coherence and distributed representation. Additionally, the multivariate time series of each production phase can be treated as convolutional channels. To describe the one-dimensional convolution operation, let Y∈ [symbol] be the arbitrary output of any 1D convolutional layer where Nₙ is the length of the output along the time axis, and Nₖ represents the number of kernels or filters. Let h denote a kernel with length Nₕ. Let V∈ [symbol] be the input of a 1D convolutional layer where Nₘ is the length of the input along the time axis and Nc represents the number of channels. For simplicity, assuming that N_{b}=1 and N_{c}=1 (i.e., a single input data point v∈ [symbol] or simply a vector v∈ [symbol] , the convolution operation for any single kernel or filter h (out of the Nₖ kernels) can mathematically be defined as:

$${y}_{j} = \{ \begin{matrix}{{\sum }_{i = 0}}^{{N}_{h}} {v}_{j + i} {h}_{i} & j = 0 \\ {{\sum }_{i = 0}}^{{N}_{h}} {v}_{j + i + ( s - 1 )} {h}_{i} & j = 1 : {N}_{m}\end{matrix}$$

where the kernel h is shifted s positions (i.e., stride) after each convolution operation. The resulting output is a single data point y∈ [symbol] or simply a vector y∈ [symbol] and is each stacked along the last axis for Nₖ kernels. The length of the output Nₙ can be calculated as:

$${N}_{n} = ⌊ \frac{{N}_{m} - {N}_{h}}{s} ⌋ + 1$$

The input can be padded to make the output length of a convolutional layer equal to the input length. When we let p be the amount of padding added to the input along the time axis, the length of the output Nₙ can be calculated as

$${N}_{n} = ⌊ \frac{{N}_{m} + 2 p - {N}_{h}}{s} ⌋ + 1$$

The input to each convolutional layer is padded to make Nₘ and Nₙ equal. Moreover, the length of the kernel Nₕ is set to be in increments of 3 months to capture the temporal trends resilient to noise. The component ƒ_{2ω} is then trained using the simulated dataset with the following loss function

$$ℒ ( ω ) = {\sum }^{{N}_{field}} {‖ {d}_{sim} - {f}_{{2}_{ω}} ( {x}_{sim} , {u}_{sim} ) ‖}_{2}^{2}$$

where once ω is learned, the prediction of the proxy model is obtained by computing \hat{d}ₛᵢₘ=ƒ_{2ω}(xₛᵢₘ, uₛᵢₘ). In the subsequent training step, the physics-constrained model ƒ_{1θ}∘ƒ_{2ω} is trained using the field dataset with the following loss function

$$ℒ ( θ ) = {\sum }^{{N}_{field}} {‖ d - {f}_{{2}_{ω}} ( {f}_{{1}_{θ}} ( x , u ) ) ‖}_{2}^{2}$$

where the parameters ω that have been initially trained using data from the physical functions are not allowed to change, while the parameters θ are allowed to be calibrated. The physics-constrained model represents the statistical information from the physical functions and the field dataset. With the trained model, the physics-constrained output prediction can be computed as \hat{d}_{c}=ƒ_{2ω}(ƒ_{1θ}(x, u)). The statistical approach of the physics-constrained model embeds the physical information from a vast dataset generated from physical functions into the neural network model to improve the predictive performance by reducing the under-determinedness of the neural network model. The diagram shown in FIG. 8B illustrates the implementation of the statistical physics-constrained model we have used for a multivariate synthetic dataset in this study. The component ƒ_{2ω} in the diagram is composed of three branches of successive convolutional layers for each flow phase, where the predictions for all phases are concatenated before the loss function is calculated. Note that other architecture variants, such as using only multiple fully-connected layers, can also achieve the same objective of representing a physics-based model. Another example of an architecture for ƒ_{2ω} is using a single branch composed of successive convolutional layers where ƒ_{2ω} directly produce a multivariate output (similar to the illustrated component ƒ_{3ζ}).

Explicit approach. In the explicit approach, a physics-based model ƒ₂ is directly embedded into a neural network by allowing the output of the preceding ƒ_{1θ} (as illustrated in FIG. 8A) to serve as input parameters p into the physical function. Specifically, the trainable component ƒ_{2ω} in FIG. 8B is replaced with a physics based model ƒ₂. Since the physics model represents causal relations between the input and output and is embedded directly (i.e., no trainable parameters), the physics-constrained model ƒ_{1θ}∘ƒ₂ can be trained in a single step using the field dataset with the following loss function:

$$ℒ ( θ ) = {\sum }^{{N}_{field}} {‖ d - {f}_{2} ( {f}_{{1}_{θ}} ( x , u ) ) ‖}_{2}^{2}$$

In the training phase, only the parameters θ within ƒ_{1θ} are calibrated and the physics-constrained output prediction can be computed as \hat{d}_{c}=ƒ₂(θ_{1θ}(x, u)). Similar to the statistical approach, the parameters within the physics-constrained model are trained using the backpropagation algorithm, where the sensitivity information flows from the loss function through the embedded physical function by invoking the chain rule. The gradient of ƒ₂ can be calculated using a closed-form solution when available or approximated through finite-difference methods. Using gradient-descent algorithm as an example, the updates to θ for any iteration i and learning rate α can be defined as

$${θ}_{i + 1} = {θ}_{i} + α \frac{δℒ}{δ {θ}_{i}} .$$

The derivative [symbol] is obtained using the chain rule as:

$$\frac{δℒ}{δθ} = \frac{δℒ}{δ {f}_{2}} \frac{δ {f}_{2}}{δ {f}_{{1}_{θ}}} \frac{δ {f}_{{1}_{θ}}}{δθ}$$

The computation of sensitivity information or derivatives can be computationally expensive for a complex physics-based model ƒ₂ that takes in high-dimensional input parameters. As such, analytical models with relatively low-dimensional input parameters are typically preferred for practical applications and are sufficient to capture the general production behavior. There are three main advantages of using the explicit approach over the statistical approach: (i) the physics-constrained model learns to transform the field input data x into p and the discovered input parameters for the physical function can be used to forecast production responses beyond the length of time available in the training data and (ii) there are significantly less number of trainable parameters in θ_{1θ}∘ƒ₂ as the physics-based model is directly embedded, leading to faster convergence and more stable results especially when the training data is limited, and (iii) the computed predictions \hat{d}_{c} are guaranteed to be physically-consistent as they are calculated by the real physics-based model (instead of a proxy model).

Physics-Guided Deep Learning (PGDL) model. Physics-constrained models (ƒ_{1θ}∘ƒ_{2ω} and ƒ_{1θ}∘ƒ₂) contain embedded physical functions that constrain the predictions. These models may yield poor performance, especially when the embedded physical functions do not fully represent the relationship between the input and output dataset due to a lack of relevance. In such cases, the predictions \hat{d}_{c} from a physics-constrained model will exhibit residual errors when compared to the ground truth d. For training purposes, the residuals dᵣ can be calculated through subtraction where dᵣ=d−\hat{d}_{c}. To compensate for the imperfect description or uncaptured physical components of the constraining physics, we introduce an auxiliary neural network component ƒ_{3ζ} with trainable parameters ζ (as illustrated in FIG. 8B) to learn the complex spatial and temporal correspondence between the well properties such as formation and completion parameters and control trajectories (as tuples of x and u) to the expected residuals dᵣ. The component ƒ_{3ζ} is trained with the following loss function

$$ℒ ( ζ ) = {\sum }^{{N}_{field}} {‖ {d}_{r} - {f}_{{3}_{ζ}} ( x , u ) ‖}_{2}^{2}$$

where once ζ is learned, the residual for any given test input parameters is obtained by computing \hat{d}ᵣ=ƒ_{3ζ}(x, u). The auxiliary component ƒ_{3ζ} can be appended to the statistical or explicit implementation of the physics-constrained model (as ƒ_{1θ}∘ƒ_{2ω}+ƒ_{3ζ} or ƒ_{1θ}∘ƒ₂+ƒ_{3ζ}), and is formalized as the Physics-Guided Deep Learning (PGDL) model as illustrated in FIG. 8A. The final prediction from the PGDL model \hat{d} is obtained by adding the prediction from the residual model \hat{d}ᵣ to the prediction from the physics-constrained model \hat{d}_{c} where \hat{d}=\hat{d}ᵣ+\hat{d}_{c}, resulting in significantly reduced under and over estimations for a more robust production prediction. The neural network architecture of ƒ_{3ζ} can include several fully-connected layers (similar to fie) followed by a decoder-style convolutional layers (similar to ƒ_{2ω}). The PGDL workflow with two choices of physics-constrained implementation for the training phase and prediction phase is illustrated as a flowchart in FIG. 8C. The PGDL models are implemented with the deep learning library Keras (version 2.2.4). Each component is trained and checkpointed using the early-stopping method. The optimal checkpoint (without overfitting) for each component is identified when validation losses do not show any further reduction.

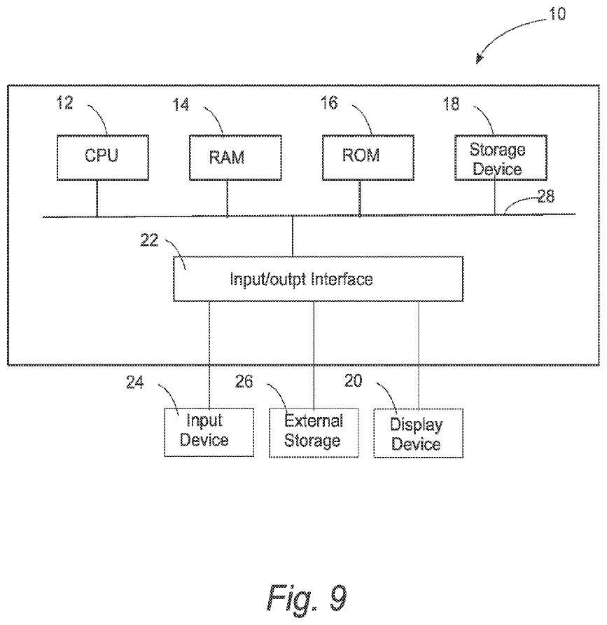

FIG. 9 provides a schematic of a computing system that can implement the method set forth above. In particular, the computing system implements the computer implemented steps set forth above can be implemented by a computer program executing on a computing device. Computing system 10 includes a processing unit 12 that executes the computer-readable instructions for the computer-implemented steps. Computer processing unit 12 can include one or more central processing units (CPU) or microprocessing units (MPU). Computer system 10 also includes RAM 14 or ROM 16 that can have computer implemented instructions encoded thereon. In some variations, computing device 10 is configured to display a user interface on display device 20.

Still referring to FIG. 9, computer system 10 can also include a secondary storage device 18, such as a hard drive. Input/output interface 22 allows interaction of computing device 10 with an input device 24 such as a keyboard and mouse, external storage 26 (e.g., DVDs and CDROMs), and a display device 20 (e.g., a monitor). Processing unit 12, the RAM 14, the ROM 16, the secondary storage device 18, and the input/output interface 20 are in electrical communication with (e.g., connected to) bus 68. During operation, computer system 10 reads computer-executable instructions (e.g., one or more programs) for the neural network methods recorded on a non-transitory computer-readable storage medium which can be secondary storage device 18 and or external storage 26. Processing unit 12 executes these reads computer-executable instructions set forth above. Specific examples of non-transitory computer-readable storage medium for which executable instructions for the computer implements methods set forth above are encoded onto include but are not limited to, a hard disk, RAM, ROM, an optical disk (e.g., compact disc, DVD), or Blu-ray Disc (BD)™), a flash memory device, a memory card, and the like. In other variations, a non-transitory storage medium can have the neural networks described above encoded thereon.

Additional details of the invention are found in Razak, Syamil Mohd, Cornelio, Jodel, Cho, Young, Liu, Hui-Hai, Vaidya, Ravimadhav, and Behnam Jafarpour. “Embedding Physical Flow Functions into Deep Learning Predictive Models for Improved Production Forecasting.” Paper presented at the SPE/AAPG/SEG Unconventional Resources Technology Conference, Houston, Texas, USA, June 2022. doi: https://doi.org/10.15530/urtec-2022-3702606; and J. Cornelio, S. Mohd Razak, A. Jahandideh, Y. Cho, H-H. Liu, R. Vaidya, and B. Jafarpour. Unconventional Resources Technology Conference, Houston, Texas, 26-28 Jul. 2021 (December 2021). https://doi.org/10.15530/urtec-2021-5688. Physics-Assisted Transfer Learning for Production Prediction in Unconventional Reservoirs and Cornelio, Jodel, Mohd Razak, Syamil, Cho, Young, Liu, Hui-Hai, Vaidya, Ravimadhav, and Behnam Jafarpour. “Residual Learning to Integrate Neural Network and Physics-Based Models for Improved Production Prediction in Unconventional Reservoirs.” SPE J. 27 (2022): 3328-3350. Doi: https://doi.org/10.2118/210559-PA and Cornelio, Jodel, Mohd Razak, Syamil, Cho, Young, Liu, Hui-Hai, Vaidya, Ravimadhav, and Behnam Jafarpour. “Transfer Learning with Prior Data-Driven Models from Multiple Unconventional Fields.” SPE J. (2023): doi: https://doi.org/10.2118/214312-PA and Mohd Razak, Syamil, Cornelio, Jodel, Cho, Young, Liu, Hui-Hai, Vaidya, Ravimadhav, and Behnam Jafarpour. “Physics-Guided Deep Learning for Improved Production Forecasting in Unconventional Reservoirs.” SPE J. (2023): SPE-214663-PA; the entire disclosures of which are hereby incorporated by reference.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method for incorporating statistical information from physical function into a neural network, the neural network including a first neural network component representing a first function and a second neural network component representing a physical function such that the second neural network component receives input from the first neural network component, each of the first neural network component and the second neural network component independently includes one or more fully-connected artificial neural network layers, the method comprising:
a) training by backpropagation the second neural network component with a first training dataset generated from at least one initial physical function in a first training phase to form a trained second neural network component, the first training dataset including pairs of an input to and an output from the second neural network component; and
b) training by backpropagation a combination of the first neural network component and the second neural network component with a second training dataset in a second training phase to form a trained neural network such that weight in the second neural network component are not allowed to change, the second training dataset generated from field data or other physical functions, the first training dataset including pairs of an input to the first neural network component and an output from the second neural network component;
wherein the trained neural network represents the statistical information from at least one initial physical function and other sets of field data or physical functions.

2. The computer implemented method of claim 1 wherein a first plurality of fully-connected layers are stacked to form the first neural network component and a second plurality of fully-connected layers are stacked to form the second neural network component.

3. The computer implemented method of claim 2, wherein each fully-connected layer includes a nonlinear activation function.

4. The computer implemented method of claim 3, wherein the number of weights within both the first neural network component and the second neural network component are sufficiently large to capture statistical relations in the first training dataset and the second training dataset.

5. The computer implemented method of claim 4, wherein backpropagation for the first neural network component and the second neural network component are each independently a mean-squared-error function or any other measure of how accurately the neural network predicts ground truth or training data.

6. A non-transitory memory encoding steps for the method of claim 1.

7. A non-transitory memory encoding the neural network formed by the method of claim 1.

8. A computing system implementing the method of claim 1.

9. A computer implemented method to combine physical functions into a neural network, the neural network including a first neural network component and a second neural network component such that the second neural network component receives input from the first neural network component, the second neural network component being a physical function, the method comprising:
a) training the neural network with a first training dataset such that only weights in the first neural network component are trained by backpropagation, the first training dataset including pairs of inputs to the first neural network component and outputs from the second neural network component.

10. The computer implemented method of claim 9 wherein the first neural network component includes one or more fully-connected artificial neural network layers.

11. The computer implemented method of claim 10, wherein the one or more fully-connected layers includes a nonlinear activation function.

12. The computer implemented method of claim 10, wherein the number of the weights in the first neural network component is sufficiently large to capture statistical relations in the first training dataset.

13. A non-transitory memory encoding steps for the computer implemented method of claim 9.

14. A non-transitory memory encoding the neural network formed by the computer implemented method of claim 9.

15. A computing system implementing the computer implemented method of claim 9.

16. A computer implemented method for improving improved prediction of a neural network for any given input by augmenting a prediction from a first neural network component that is a physics-constrained neural network with a predicted residual output from a second neural network component that is a trained neural network, the method including a training phase comprising:
obtaining a training dataset that includes dataset pairs of a training input to the first neural network component and a training output from the first neural network component;
calculating a calculated output from the first neural network component for each training input;
calculating the predicted residual output as a difference between the calculated output and the training output; and
training the second neural network component with a second training dataset that includes pairs of the training input and the predicted residual output.

17. The computer implemented method of claim 16 further including a prediction phase comprising:
providing a set of input data;
calculating the calculated output from the first neural network component for each input in the set of input data;
calculating a residual output from the second neural network component for each input in the set of input data; and
calculating a final out as a sum of the residual output and the calculated output.

18. The computer implemented method of claim 16, wherein a first plurality of fully-connected layers are stacked to form the first neural network component and a second plurality of fully-connected layers are stacked to form the second neural network component.

19. The computer implemented method of claim 18, wherein each fully-connected layer includes a nonlinear activation function.

20. The computer implemented method of claim 19, wherein backpropagation for the first neural network component and the second neural network component are each independently a mean-squared-error function or any other measure of how accurately the neural network predicts ground truth or training data.

21. A non-transitory memory encoding steps for the method of claim 16.

22. A non-transitory memory encoding the neural network formed by the method of claim 16.

23. A computing system implementing the method of claim 16.

24. A computer implemented method to identify and rank source models for transfer learning with a neural network, the computer implemented method comprising:
providing a plurality of input datasets;
isolating unique characteristics of each dataset in the plurality of input datasets by subtracting a predetermined function from each input dataset to obtain residual dataset for each input dataset; and
generating a low-dimensional representation with an encoder by the neural network receiving as input each residual dataset, the neural network passing the residual dataset through a series of successive layers thereby generating a low-dimensional representation as a set of latent variables for each residual dataset.

25. The computer implemented method of claim 24 further comprising providing each residual dataset to a decoder that reshapes the latent variables and gradually up-samples to produce a reconstruction in full dimension.

26. The computer implemented method of claim 24, wherein the encoder including repeating layers, a one-dimensional convolutional function, followed by a non-linear activation leaky-ReLU function and lastly a one-dimensional pooling operation.

27. A non-transitory memory encoding steps for the method of claim 24.

28. A non-transitory memory encoding the neural network formed by the method of claim 24.

29. A computing system implementing the method of claim 24.

30. A computer-implemented method for aggregating source models predictions for transfer learning with a neural network that includes multiple neural network components that provide input to a final neural network component, each of the multiple neural network components corresponding to a source model, the computer-implemented method comprising:
training, by backpropagation, each of the multiple neural network components corresponding to a source model with different datasets; and
training the final neural network component with a first training dataset including pairs of inputs to the multiple neural network components and an output from the final neural network component, the training of the final neural network component being performed without varying weight in the multiple neural network components, wherein the final neural network component incorporates features from different outputs of the multiple neural network components such that output from the final neural network component matches output of the first training dataset thereby allowing the neural network to make predictions.

31. The computer-implemented method of claim 30 wherein each of the multiple neural network components corresponding to a source model independently includes fully-connected layers.

32. The computer-implemented method of claim 31 wherein each of the fully-connected layers includes nonlinear activation functions.

33. A non-transitory memory encoding steps for the method of claim 30.

34. A non-transitory memory encoding the neural network formed by the method of claim 30.

35. A computing system implementing the method of claim 30.

36. A computer-implemented method for identifying which source models are accurate and are contributing to a target dataset to facilitate transfer learning with a neural network that includes multiple neural network components that provide input to a final neural network component, the computer-implemented method comprising:
training, by backpropagation, each of the multiple neural network components corresponding to a source model with different datasets; and
training the final neural network component with a first training dataset including pairs of inputs to the multiple neural network components and an output from the final neural network component, the training of the final neural network component being performed without varying weight in the multiple neural network components wherein the final neural network component including a first layer that applies a SoftMax activation function before being mapped to a final output vector, the first layer being designed such that the number of hidden nodes is the same as the number of source models used during training of the final neural network component such that activations can be extracted to determine probabilities of different source models relative to a target dataset.

37. The computer-implemented method of claim 36 wherein each of the multiple neural network components corresponding to a source model independently includes fully-connected layers.

38. The computer-implemented method of claim 37 wherein each of the fully-connected layers includes nonlinear activation functions.

39. A non-transitory memory encoding steps for the method of claim 36.

40. A non-transitory memory encoding the neural network formed by the method of claim 36.

41. A computing system implementing the method of claim 36.
